(19) United States
(12) Patent Application Publication
(10) Pub. No.: US 2002/0152979 A1
(43) Pub. Date: Oct. 24, 2002

(54) Internal combustion engine with heat accumulator

(75) Inventors: Kunihiko Hayashi, Ashigarakami-gun (JP); Kazuki Iwatani, Susuno-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/121,595

(22) Filed: Apr. 15, 2002

(30) Foreign Application Priority Data
Apr. 20, 2001 (JP) 2001-122597
Feb. 21, 2002 (JP) 2002-45109

(51) Int. Cl. F02N 17/02

(52) U.S. Cl. 123/142.5 R

(57) ABSTRACT

An internal combustion engine includes a heat accumulator to accumulate heat from a heat medium, a heat supplier to supply the heat medium accumulated in the heat accumulator to the internal combustion engine, and plural inlets to introduce the heat medium supplied by the heat supplier to each cylinder of the internal combustion engine. Differences in temperature among the cylinders are decreased since the warmed heat medium flows into each cylinder directly.

### INCORPORATION BY REFERENCE

The disclosures of Japanese Patent Application No. 2001-122597 filed on Apr. 20, 2001 and No. 2002-045109 filed on Feb. 21, 2002 including the specification, drawings and abstract are incorporated herein by reference in their entirety.

### BACKGROUND OF THE INVENTION

1. Field of the invention

The present invention relates to an internal combustion engine equipped with a heat accumulator.

2. Description of Related Art

Generally, when an internal combustion engine is running under conditions in which a temperature around combustion chambers is below a predetermined temperature, in other words, running under cold conditions, atomization of fuel supplied to the combustion chambers deteriorates and exhaust gas emission also deteriorates due to quenching around walls of the combustion chambers.

In order to obviate this problem, an internal combustion engine equipped with a heat accumulator is being developed which can accumulate heat generated by the combustion when the engine is running. Then the accumulated heat is supplied to the engine when the engine is not running or the engine needs to be started. However, the amount of heat accumulated in the heat accumulator is limited, and therefore it is important to utilize the heat effectively.

According to a Japanese Patent Laid-Open Publication No. HEI 6-185359, an engine is equipped with a first water coolant channel which supplies water coolant to a cylinder block, a second water coolant channel which supplies water coolant to a cylinder head independently and a heat accumulator connected to the second water coolant channel.

The heat accumulator for the internal combustion engine comprising according to the above prior art supplies heat to the cylinder head intensively through the second water coolant channel. The heat accumulated in the heat accumulator, when the engine is under cold conditions, is supplied with water coolant as a medium. It is an object of the internal combustion engine disclosed in the prior art (equipped with the first water coolant channel which supplies water coolant to the cylinder block, the second water coolant channel which supplies water coolant to the cylinder head independently of the first water channel, and the heat accumulator connected to the second water coolant channel) to supply heat accumulated in the heat accumulator to the cylinder head intensively so that the limited amount of heat can be supplied to the internal combustion engine effectively. Therefore, emission performance and fuel efficiency can be improved.

However, it takes a while for water coolant to flow in the internal combustion engine from one inlet to reach the last cylinder through each cylinder. If a user starts the engine before the water coolant reaches the last cylinder, it is possible that the exhaust gas emission deteriorates due to insufficient temperature rise in a cylinder far from the water coolant inlet.

In the meantime, high-temperature water coolant circulates in a cylinder around a water coolant inlet. However, if the water coolant temperature lowers when the water coolant reaches a cylinder far from the water coolant inlet, differences in temperature are caused among the cylinders due to insufficient temperature rise. It leads to causing differences in air-fuel ratio in the cylinders. As a result, the optimal air-fuel ratio can be achieved in one cylinder, however it can not be obtained in the other cylinders. Therefore, it takes some difficulties and a complicated control to run the engine in consideration of the differences in temperature in the cylinders.

### SUMMARY OF THE INVENTION

It is an object of the present invention to provide techniques, which are for obviating the above problems, to raise a temperature of an internal combustion engine equipped with a heat accumulator rapidly and equally.

The above-mentioned main object of the invention can be achieved by providing an internal combustion engine equipped with a heat accumulator to accumulate heat from a heat medium (as a heat accumulator), a heat supplier to supply the heat medium accumulated in the heat accumulator, and plural inlets to introduce the heat medium supplied by the heat supplier to the internal combustion engine.

### BRIEF DESCRIPTION OF THE DRAWINGS

FIG. 1 is a schematic view of an engine applying a heat accumulator for an internal combustion engine and water coolant channels in which water coolant circulates according to a first embodiment;

FIG. 2 is a block diagram showing internal parts of an ECU;

FIG. 3 is a view of the water coolant circulation directions when an engine-preheat control is carried out according to the first embodiment;

FIG. 4 is a schematic view of an engine applying a heat accumulator for an internal combustion engine and water coolant channels in which water coolant circulates according to a second embodiment;

FIG. 5 is a view of the water coolant circulation directions when the engine-preheat control is carried out according to the second embodiment;

FIG. 6 is a schematic view of an engine 1 applying a heat accumulator for an internal combustion engine and water coolant channels (circulation channels) in which water coolant circulates according to a third embodiment;

FIG. 7 is a schematic view showing a cylinder head including a water coolant inlet at a central part of a water jacket;

FIG. 8 is a schematic view of an engine applying a heat accumulator for an internal combustion engine and water coolant channels in which water coolant circulates according to a fourth embodiment;

FIG. 9 is a view of the water coolant circulation directions when the engine-preheat control is carried out according to the fourth embodiment;

FIG. 10 is a schematic view of a cylinder head including a water coolant inlet eccentrically provided to the side of a water coolant outlet from the center of each cylinder;

FIG. 11 is a schematic view of a cylinder head including a water coolant inlet located on the center axis of each cylinder;

FIG. 12 is a schematic view of an in-pipe fuel-injected internal combustion engine including a water coolant inlet located at a cylinder block;

FIG. 13 is a schematic view of an in-pipe fuel-injected internal combustion engine including two water coolant inlets located at a cylinder block;

FIG. 14 is a schematic view of an in-port fuel-injected internal combustion engine including water coolant inlets located at a cylinder head and a cylinder block.

### DETAILED DESCRIPTION OF THE PREFERRED EMBODIMENTS

The following explains detailed preferred embodiments according to the drawings mentioned above. This part explains a heat accumulator for an internal combustion engine according to the present invention by giving the example of applying a heat accumulator to an engine of a vehicle run by gasoline.

A water coolant inlet according to the present invention represents any portion in which a heat medium flows around an effective portion to warm up the internal combustion engine (warm-up effective portion hereafter). A water coolant inlet does not limitedly represent a portion connecting the interior and exterior of the internal combustion engine. In other words, it can be said that a heat medium flows through a water coolant inlet according to the present invention and flows into the warm-up effective portion in the interior of the internal combustion engine.

A cylinder of an internal combustion engine can be presented as an example of the warm-up effective portion mentioned above. And a combustion chamber of each cylinder or an intake port can be presented as a detailed example.

The First Embodiment

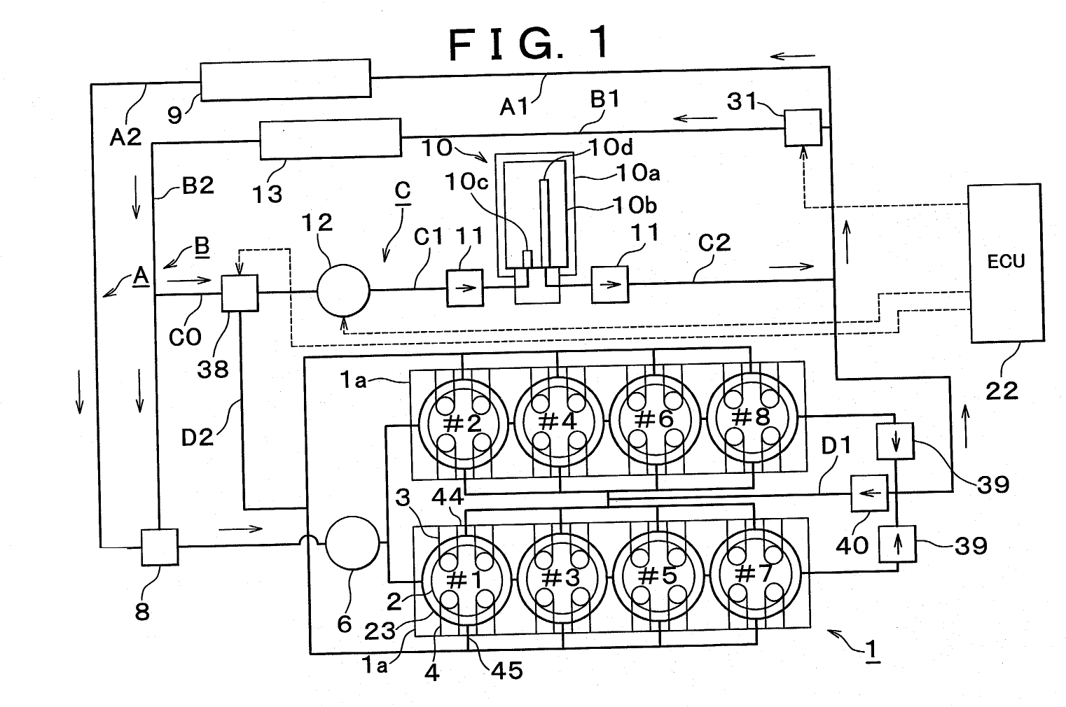

FIG. 1 is a schematic view which shows an engine 1 applying a heat accumulator for the internal combustion engine according to the present invention and water coolant channels A, B, and C (circulation channels). The arrows indicated in the circulation channels represent the flowing directions of water coolant when the engine 1 is running.

The engine 1 shown in FIG. 1 is a water-cooled 4-cycle V-type engine with 8 cylinders which is run by gasoline and equipped with two cylinder heads 1a.

The cylinder heads 1a are equipped with a water jacket 23 through which water coolant circulates. A water pump 6, which sucks in water coolant outside the engine 1 and spurts out the water coolant inside the engine 1, is provided at the water coolant inlet of the water jacket 23. The water pump 6 is driven by torque of the output shaft of the engine 1. In other words, the water pump 6 can only be driven when the engine 1 is running.

There are three circulation channels as channels to circulate water coolant through the engine 1: a circulation channel A which circulates through a radiator 9, a circulation channel B which circulates through a heater core 13, and a circulation channel C which circulates through a heat accumulator 10. Each circulation channel shares a section with another circulation channel.

The circulation channel A has the main function of lowering water coolant temperature by emitting heat of the water coolant from the radiator 9.

The circulation channel A includes a radiator inlet-side channels A1, a radiator outlet-side channel A2, the radiator 9, and the water jacket 23. One end of the radiator inlet-side channel A1 is branched and connected to the two cylinder heads 1a. The other end of radiator inlet-side channel A1 is connected to the water coolant inlet of the radiator 9. The section from the water jacket 23 to the merging point of the branched radiator inlet-side channel A1 has reverse flow-preventing valves 39 which circulate water coolant only in the directions of the arrows shown in FIG. 1.

One end of the radiator outlet-side channel A2 is connected to the water coolant outlet of the radiator 9. The other end of the radiator outlet-side channel A2 is connected to a cylinder block (not shown). The radiator outlet-side channel A2 from the water coolant outlet of the radiator 9 to the cylinder block has a thermostat 8. The thermostat 8 has the function of opening its valve when water coolant reaches a predetermined temperature. The water pump 6 is located between the radiator outlet-side channel A2 and the cylinder block.

The circulation channel B has the main function of raising ambient temperature in a compartment by emitting heat of water coolant from the heater core 13.

The circulation channel B includes a heater core inlet-side channel B1, a heater core outlet-side channel B2, the heater core 13, and the water jacket 23. One end of the heater core inlet-side channel B1 is connected to a point midway of the radiator inlet-side channel A1. A channel from the cylinder heads 1a to the connection described above, which is a part of the heater core inlet-side channel B1, is shared by the radiator inlet-side channel A1. The other end of the heater core inlet-side channel B1 is connected to the water coolant inlet of the heater core 13. A shut-off valve 31, which is opened and closed by the signals from an ECU 22, is located midway of the heater core inlet-side channel B1. One end of the heater core outlet-side channel B2 is connected to the water coolant outlet of the heater 13. The other end of the heart core outlet-side channel B2 is connected to a point between the thermostat 8, which is located midway of the radiator outlet-side channel A2, and the water pump 6. The water pump 23 and a channel from the connection described above to the cylinder block are shared by the radiator outlet-side channel A2.

The circulation channel C has the main function of warming the engine 1 by accumulating heat of water coolant and emitting the accumulated heat.

The circulation channel C includes a heat accumulator inlet-side channel C1, a heat accumulator outlet-side channel C2, the heat accumulator 10, a preheated water coolant inlet-side channel D1, a preheated water coolant outlet-side channel D2, and the water jacket 23. The following is how the circulation channel C is connected when the engine 1 is running. One end of the heat accumulator inlet-side channel Cl is connected to one end of a connecting channel C0 thorough a flow path-switching valve 38 which is controlled by the signals from the ECU 22. The other end of the connecting channel C0 is connected to a point midway of the heater core outlet-side channel B2. A channel from the cylinder heads 1a to the connection described above is shared by the circulation channel A and B. The other end of the heat accumulator inlet-side channel C1 is connected to the water coolant inlet of the heat accumulator 10. One end of the heat accumulator outlet-side channel C2 is connected to the water coolant outlet of the heat accumulator 10. The other end of the heat accumulator outlet-side channel C2 is connected to a point midway of the radiator inlet-side channel A1. A reverse flow-preventing valves 11, which circulate water coolant only in the direction shown in FIG. 1, are located at the water coolant inlet and outlet of the heat accumulator 10.

On the other hand, the following shows how the circulation channel C is connected when the engine 1 is turned off. One end of the heat accumulator inlet-side channel C1 is connected to the flow path-switching valve 38 which is controlled by the signals from the ECU 22. The valve is connected to one end of the preheated water coolant outlet-side channel D2. The other end of the preheated water coolant outlet-side channel D2 is connected to the cylinder heads 1a by branching eightfold since the number of the cylinders 2 is eight. One end of the heat accumulator outlet-side channel C2 is connected to the water coolant outlet of the heat accumulator 10. The other end of the heat accumulator outlet-side channel C2 is connected to a point midway of the radiator inlet-side channel A1. One end of the preheated water coolant inlet-side channel D1 is connected to a point between the reverse flow-preventing valves 39 and the connection. The other end of the preheated water coolant inlet-side channel D1 is connected to the cylinder heads 1a by branching eightfold since the number of cylinders 2 is eight. A reverse flow-preventing valve 40, which circulates water coolant only in the direction shown in FIG. 1, is located midway of the preheated water coolant inlet-side channel D1.

Furthermore, a motor-driven water pump 12 is located midway of the heat accumulator inlet-side channel C1 and upstream the reverse flow-preventing valve 11.

A water pump on the circulation channels according to the above description works as follows. Torque from a crankshaft (not shown) is transmitted to the input shaft of the water pump 6 when the engine 1 is running. Then the pump 6 spurts out water coolant driven by pressure according to the torque transmitted to the input shaft of the water pump 6.

The water coolant spurted out of the water pump 6 circulates through the water jacket 23. At this time, heat is conducted through the cylinder heads 1a, the interior of the cylinder block, and the water coolant. Some of the heat generated by combustion in the cylinders 2 is conducted to the walls of the cylinders 2. Then the heat is conducted to the cylinder heads 1a and the interior of the cylinder block. As a result, temperatures at the cylinder heads 1a and the entire cylinder block rise. Some of the hest conducted to the cylinder heads 1a and the cylinder block is conducted to the water coolant in the water jacket 23. Then the temperature of the water coolant is raised. As a result, temperatures at the cylinder heads 1a and the cylinder block drop due to heat loss. As described above, the temperature of the water coolant is raised when the engine 1 is running. And the water coolant flows out to the radiator inlet-side channel A1 from the cylinder block. The water coolant does not flow into the reheated water coolant inlet-side channel D1 since the channel has the reverse flow-preventing valve 40. At the same time, the water coolant does not flow into the preheated water coolant outlet-side channel D2 since the flow path-switching valve 38 is located between the heat accumulator inlet-side channel C1 and the connecting channel C0.

The water coolant, which flows out to the radiator inlet-side channel A1, flows into the radiator 9 through the radiator inlet-side channel A1. At this time, heat is conducted to open air from the water coolant. Some of the heat of the high-temperature water coolant is conducted to the walls of the radiator 9. And the heat is conducted to the interior of the radiator 9 which leads to raising the temperature of the entire radiator 9. Then some of the heat, which is conducted to the radiator 9, is conducted to open air. As a result, the temperature of the open air rises. And the temperature of the water coolant drops due to heat loss. The lower-temperature water coolant flows out of the radiator 9.

The water coolant, which flows out of the radiator 9, reaches the thermostat 8 through the radiator outlet-side channel A2. When the water coolant, which flows through the heater core outlet-side channel B2, reaches a predetermined temperature, internally stored wax expands to a certain extent. Then the thermostat 8 opens automatically by the heat expanding of the wax. In other words, the radiator outlet-side channel A2 is shut off when the water coolant, which flows through the heater core outlet-side channel B2, does not reach a predetermined temperature. As a result, the water coolant in the radiator outlet-side channel A2 cannot pass the thermostat 8.

The water coolant, which passes through the thermostat 8, flows into the water pump 6 when the thermostat 8 is open.

As described above, the thermostat 8 opens and the water coolant circulates in the radiator 9 only when the water coolant reaches a predetermined temperature. The lower-temperature water coolant, which flows through the radiator 9, is spurted out of the water pump 6 to the water jacket 23. Then the temperature of the water coolant rerises.

In the meantime, some of the water coolant, which flows through the radiator inlet-side channel A1, flows into the heater core inlet-side channel B1.

The water coolant, which flows into the heater core inlet-side channel B1, reaches the shut-off valve 31 through the heater core inlet-side channel B1. The shut-off valve 31 is operated by the signals from the ECU 22. The valve is open when the engine 1 is running and the valve is closed when the engine 1 is turned off. The water coolant reaches the heater core 13 after passing the shut-off valve 31 and flowing through the heater core inlet-side channel B1 when the engine 1 is running.

The Heater core 13 exchanges heat with air in a compartment. The warmed air circulates in the compartment by a fan (not shown). As a result, ambient temperature in the compartment rises. Then the water coolant merges into the radiator outlet-side channel A2 after flowing out of the heater core 13 and flowing through the heater core outlet-side channel B2. At this time, the water coolant flows into the water pump 6 after merging with the water coolant in the circulation channel A when the thermostat 8 is open. On the other hand, only the water coolant, which flows through the circulation channel B, flows into the water pump 6 when the thermostat 8 is closed.

As described above, the water coolant, which drops its temperature through the heater core 13, is spurted out of the water pump 6 to the water jacket 23 again.

In this connection, it is necessary that water coolant temperature be raised rapidly when the temperature of the water coolant is lower than a predetermined temperature. In this case, the water coolant drops its temperature when flowing through radiator. Therefore, it is possible that the water coolant does not reach the predetermined temperature; otherwise it takes a while for the water coolant to reach the predetermined temperature. To prevent the above-mentioned status, the thermostat 8 is provided so that the water coolant does not circulate in the radiator 9 and drop its temperature since the thermostat 8 is automatically closed. And low-temperature water coolant does not reversely flow into the heat accumulator 10 since the heat accumulator 10 is located between the reverse flow-preventing valves 11.

The engine 1 formed according to the above description has the electronic control unit (ECU hereafter) 22 to control the engine 1. This ECU 22 controls running status of the engine 1 according to running conditions of the engine 1 and requirements from a user. The ECU 22 also has the function of temperature raising control (engine preheat control) when the engine 1 is turned off. The ECU 22 has various sensors such as a crank position sensor (not shown) and a water coolant temperature sensor (not shown). These sensors are connected each other through electrical wiring so that output signals from the sensors can be inputted to the ECU 22.

Furthermore, the ECU 22 is connected through electrical wiring with various parts in the engine 1 such as the motor-driven water pump 12, the shut-off valve 31, and the flow path-switching valve 38 to control these parts.

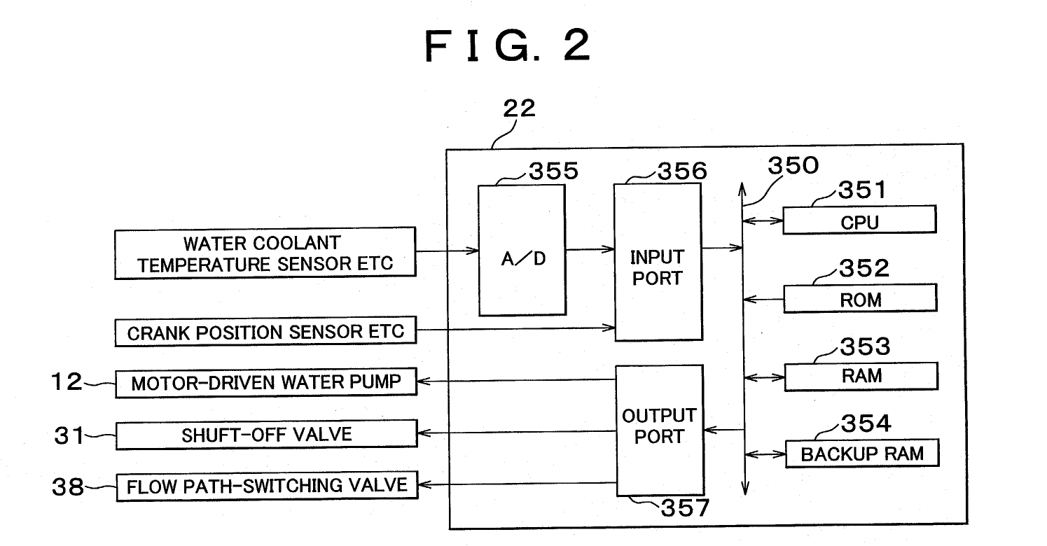

As shown in FIG. 2, the ECU 22 is equipped with a CPU 351, a ROM 352, a RAM 353, a backup RAM 354, an input port 356, and an output port 357 all of which are connected each other by a bi-directional bus 350. The input port 356 is connected to an A/D converter 355 (A/D 355 hereafter).

The input port 356 inputs output signals from sensors such as a crank position sensor which outputs digital signals. Then the input port 356 transfers these signals to the CPU 351 and the RAM 353.

The input port 356 inputs output signals through the A/D 355 which outputs analog signals such as a water coolant temperature sensor (not shown). Then the input port 356 transfers these signals to the CPU 351 and the RAM 353.

The output port 357 is connected through electrical wiring with various parts in the engine 1 such as the motor-driven water pump 12, the shut-off valve 31, and the flow path-switching valve 38. And the output port 357 transfers control signals outputted from the CPU 351 to the above-mentioned parts such as the motor-driven water pump 12, the shut-off valve 31, and the flow path-switching valve 38.

The ROM 352 stores application programs such as engine preheat-controlling routine to supply heat from the heat accumulator 10 to the engine 1.

In addition to the above-mentioned application program, the ROM 352 stores various control maps such as fuel injection-controlling map which shows relation between running status of the engine 1 and basic fuel injection amount (basic fuel injection time). Fuel injection timing-controlling map, which shows relation between running status of the engine 1 and basic fuel injection timing, can be presented as another example of a control map.

The RAM 353 stores output signals from each sensor, arithmetic result from the CPU 351 and so on. Engine revolution calculated according to pulse signal intervals from a crank position sensor can be presented as an example of arithmetic result. Data are updated whenever the crank position sensor outputs pulse signals.

The RAM 354 is nonvolatile memory which can store data even if the engine 1 is turned off.

The following explains summary of temperature raising control (engine preheat control hereafter) of the engine 1 according to the present preferred embodiment.

When the engine 1 is running, the ECU 22 transfers signals to the motor-driven water pump 12 to start the pump. Then water coolant circulates in the circulation channel C. At this time, water coolant can flow into the heat accumulator inlet-side channel C1 from the connecting channel C0 through the flow path-switching valve 38. Therefore, some of the water coolant, which flows through the heater core outlet-side channel B2, flows into the heat accumulator inlet-side channel C1. The water coolant, which flows into the heat accumulator inlet-side channel C1, reaches the motor-driven water pump 12 through the heat accumulator inlet-side channel C1.

The water coolant, which is spurted out of the motor-driven water pump 12, reaches the heat accumulator 10 through the heat accumulator inlet-side channel C1 and passing the reverse flow-preventing valve 11. The heat accumulator 10 has evacuated heat insulation space between the exterior of a container 10a and the interior of a container 10b. The water coolant, which flows into the heat accumulator 10, is insulated from outside and is inhibited a decrease in temperature of the water coolant for a while. And the water coolant, which flows in through a water coolant injection tube 10c, flows out of a water coolant extraction tube 10d.

The water coolant, which flows out of the heat accumulator 10, flows into the radiator inlet-side channel A1 after passing the reverse flow-preventing valve 11 and flowing through the heat accumulator outlet-side channel C2.

The water coolant, which flows out of the heat accumulator outlet-side channel C2 and flows into the radiator inlet-side channel A1, flows in different directions depending on whether the engine 1 is running or not. The water coolant flows toward the radiator 9 and the heater core 13 after merging with the water coolant which flows out of the engine 1 when the engine 1 is running.

As described above, the water coolant, whose temperature has been raised by the engine 1, flows through the interior of the heat accumulator 10. And the interior of the heat accumulator 10 is filled with high-temperature water coolant. Then the high-temperature water coolant can be stored in the heat accumulator 10 when the ECU 22 stops operating the motor-driven water pump 12 after the engine 1 is turned off. By the insulation effect of the heat accumulator 10, dropping temperature of the stored water coolant is restrained. The ECU 22 also performs engine preheat control of the cylinder heads 1a by circulating the high-temperature water coolant, which is stored in the heat accumulator 10, in the circulation channel C.

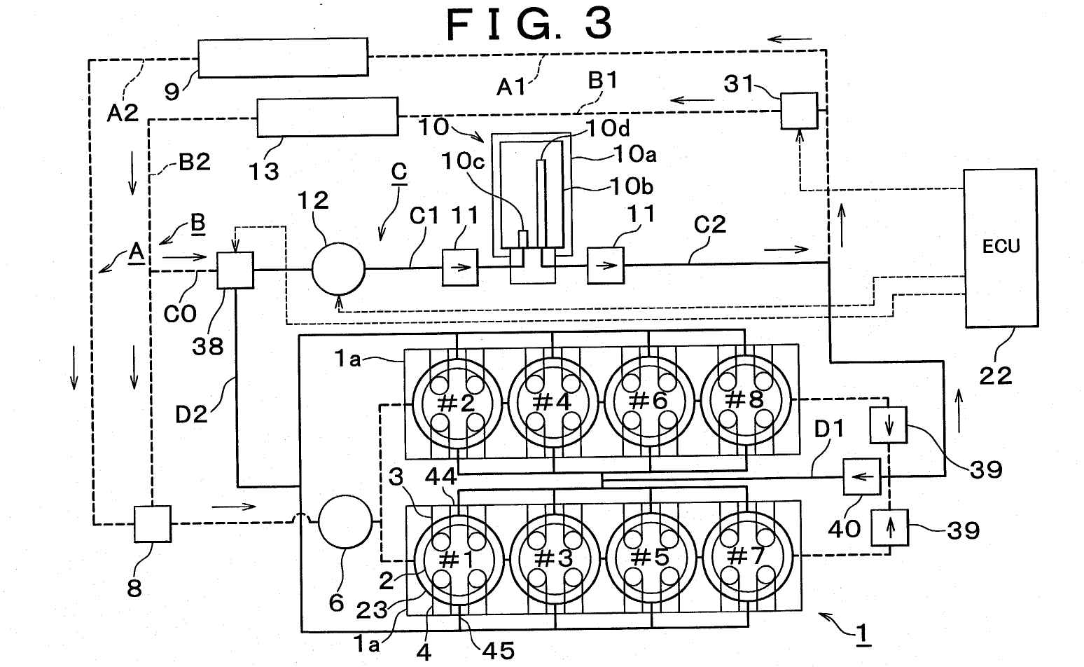

FIG. 3 shows the water coolant circulation channels and the water coolant circulation directions when heat from the heat accumulator 10 is supplied to the engine 1 and the engine 1 is turned off.

The shut-off valve 31 is closed by the ECU 22 when the engine preheat control is performed. At this time, the section from the preheated water coolant inlet-side channel D2 to the heat accumulator inlet-side channel C1 is open through the flow path-switching valve 38. The motor-driven water pump 12 is driven according to the signals from the ECU 22 and spurts out water coolant with a predetermined pressure when the engine preheat control is performed. The spurted out water coolant reaches the heat accumulator 10 through the heat accumulator inlet-side channel C1 and passing the reverse flow-preventing valve 11. At this time, the water coolant, which flows into the heat accumulator 10, is the water coolant whose temperature is lowered when the engine 1 is turned off.

The water coolant, which is stored in the heat accumulator 10, flows out of the heat accumulator 10 through the water coolant extraction tube 10d. At this time, the water coolant, which flows out of the heat accumulator 10, is the water coolant which is insulated by the heat accumulator 10 after flowing into the heat accumulator 10 when the engine 1 is running. The water coolant, which flows out of the heat accumulator 10, reaches the radiator inlet-side channel A1 after passing the reverse flow-preventing valve 11 and flowing through the heat accumulator outlet-side channel C2. When the engine 1 is turned off, water coolant does not circulate in the heater core 13 since the shut-off valve 31 is closed according to the signal from the ECU 22. And the engine preheat control is not performed when water coolant temperature is higher than the opening valve temperature of the thermostat 8 since it is not necessary to supply heat from the heat accumulator 10 to the engine 1. In other words, when water coolant circulates and the engine 1 is turned off, the thermostat 8 is always closed. Therefore, water coolant temperature does not drop due to heat conduction since water coolant does not circulate in the heater core 13 and the radiator 9. As described above, water coolant does not flow in the directions of the radiator 9 and the heater core 13 but flows toward the cylinder heads 1a.

Then the water coolant reaches the reverse flow-preventing valve 39 and the reverse flow-preventing valve 40 through the radiator inlet-side channel A1. At this time, the water coolant cannot pass the reverse flow-preventing valve 39 but the reverse flow-preventing valve 40. The water coolant, which passes the reverse flow-preventing valve 40, flows into the cylinder heads 1a through eight inlets 44 located on the side of the intake ports 3 through the preheated water coolant inlet-side channel D1 and being branched.

The water coolant, which flows into the cylinder heads 1a, flows through the water jacket 23. The cylinder heads 1a exchange heat with the water coolant in the water jacket 23. Some of the heat from the water coolant is conducted to the interior of the cylinder heads 1a and temperatures of the entire cylinder heads 1a rise. As a result, the temperature of the water coolant drops due to heat loss. At this time, the water coolant does not flow out to the radiator outlet-side channel A2 through the water pump 6 since the thermostat 8 and the shut-off valve 31 is closed. Therefore, the water coolant, which flows through the water jacket 23, flows into the preheated water coolant outlet-side channel D2 after flowing out of eight water coolant inlets 45 located on the side of the intake ports 4 of the cylinder heads 1a. The water coolant, which flows out of the eight water coolant inlets 45, merges into the preheated water coolant outlet-side channel D2 and reaches the motor-driven water pump 12 through the flow path-switching valve 38.

As described above, the ECU 22 performs the engine preheat control of the cylinder heads 1a by activating the motor-driven water pump 12 prior to starting the engine 1.

In connection with the description above, the following explains a conventional system, which exchanges heat between the engine 1 and the heat accumulator 10 by water coolant circulating the engine 1 and the heat accumulator 10. The water coolant, stored in the heat accumulator 10, flows out on the side of the water pump 6 after raising temperatures of the cylinders 2 in order and flowing through the water jacket 23 when the water coolant (heated water), which is stored in the heat accumulator 10, is supplied to the cylinder heads 1a. At this time, the temperature of the water coolant gradually drops, since the water coolant flows through the water jacket 23 and exchanges heat with the cylinder heads 1a at the same time. Therefore, a difference in temperature is generated between one of the cylinders 2 on the side of the water coolant inlet-side and another cylinder 2 on the side of the water coolant outlet-side. In this case, operation control required of each cylinder 2 is different. And the above-mentioned operation control takes some difficulties since complicated devices and control are needed.

It also takes a while for water coolant to pass all the cylinders 2 and raise the temperatures of all the cylinders 2 since the water coolant flows through the cylinders 2 in order. If a period of raising the temperatures of all the cylinders 2 is prolonged, it increases the chance that a user starts the engine 1 before the engine 1 is preheated sufficiently. Therefore, it is important to shorten a period of finishing the engine preheat control.

To obviate the above-mentioned problem, each cylinder 2 has one of the water coolant inlets 44 and one of the water coolant outlets 45 according to the present preferred embodiment. Therefore, differences in temperature among the cylinders 2 can be decreased since water coolant flows through each cylinder 2. And the water coolant, which flows into one of the cylinder heads 1a from one of the water coolant inlets 44, only raises the temperature of one of the cylinders 2 so that a period of finishing the engine preheat control can be shortened.

Water coolant may be heated by a device such as a heater according to the present preferred embodiment so that the lower-temperature water coolant, which supplies heat to the engine 1, can be heated. Therefore, the engine 1 can be heated for a long period.

Different operation control may be performed for each cylinder according to the present preferred embodiment.

As explained above, rapid raising temperatures of the cylinders 2 is possible when the engine 1 is turned off according to the present preferred embodiment. As a result, a warm-up period can be shortened dramatically. And differences in temperature among the cylinders 2 can be decreased. Therefore, stating the engine 1 without raising temperatures of the cylinders 2 sufficiently can be prevented.

The Second Embodiment

The following explains the differences between the engine 1 according to the first embodiment and an engine 1 equipped with heat accumulators according to this second embodiment.

The engine 1 is equipped with one heat accumulator and water coolant is supplied to each cylinder 2 from the heat accumulator through each water coolant inlet 44 according to the first embodiment. On the other hand, an engine is equipped with two heat accumulators according to the second embodiment. And the two heat accumulators can supply heat independently. A circulation channel, which is connected to each water coolant inlet 44 of each cylinder 2, is only connected to one heat accumulator.

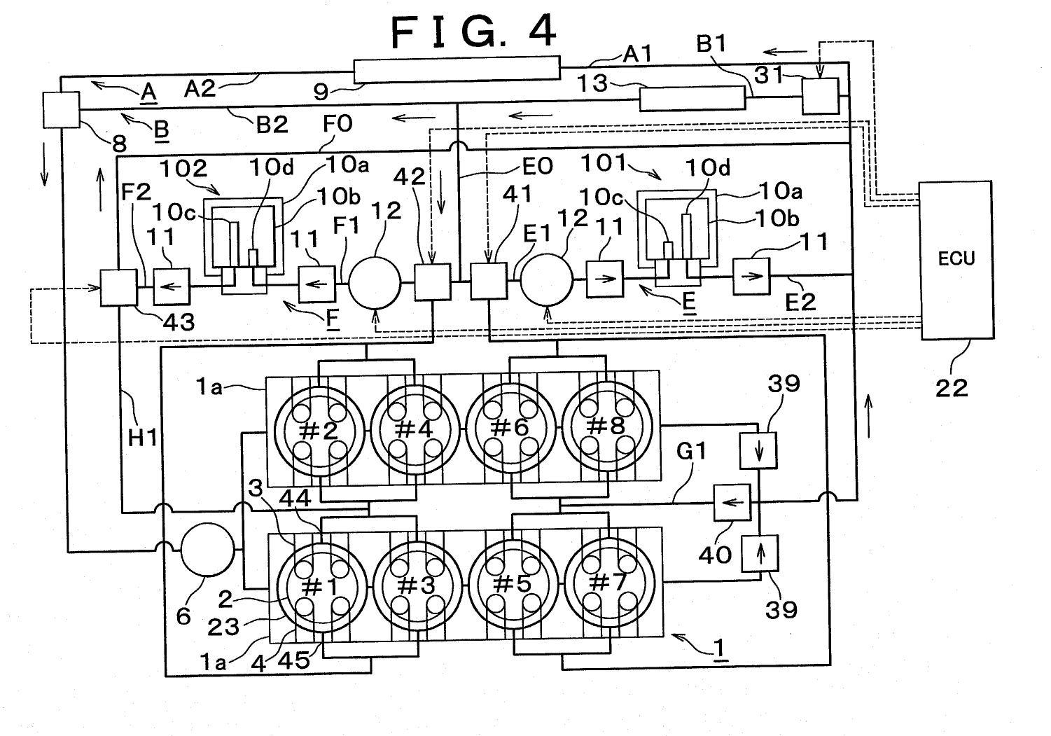

FIG. 4 is a schematic view which shows the engine 1 applying the heat accumulators of the internal combustion engine according to the present invention and water coolant channels A, B, E, and F (circulation channels). Since a circulation channel A with the radiator 9 and a circulation channel B with the heater core 13 are substantially identical to the circulation channel A and the circulation channel B based on the first embodiment, the explanation about the circulation channel A and circulation channel B is omitted.

The circulation channel E includes a connecting channel E0, a heat accumulator inlet-side channel E1, a heat accumulator outlet-side channel E2, a heat accumulator 101, a preheated water coolant inlet-side channel G1, a preheated water coolant outlet-side channel G2, and the water jacket 23. The following is how the circulation channel E is connected when the engine 1 is running. One end of the heat accumulator inlet-side channel E1 is connected to one end of the connecting channel E0 through a flow path-switching valve 41. The other end of the connecting channel E0 is connected to a point midway of the heater core outlet-side channel B2. A channel from the cylinder heads 1a to the connection of the heater core outlet-side channel B2 is shared by the circulation channel A and B. The other end of the heat accumulator inlet-side channel E1 is connected to the water coolant inlet of the heat accumulator 101. One end of the heat accumulator outlet-side channel E2 is connected to the water coolant outlet of the heat accumulator 101. The other end of the heat accumulator outlet-side channel E2 is connected to a point midway of the radiator inlet-side channel A1. The reverse flow-preventing valves 11, which circulate water coolant only in the direction shown in FIG. 4, are located at the water coolant inlet and outlet of the heat accumulator 101.

On the other hand, the following is how the circulation channel E is connected when the engine 1 is turned off. One end of the heat accumulator inlet-side channel E1 is connected to one end of the preheated water coolant outlet-side channel G2 through the flow path-switching valve 41. The other end of the preheated water coolant outlet-side channel G2 branches fourfold and the branched channels are connected to the water coolant outlets 45 for the corresponding cylinders 2 (#5˜#8) located at the cylinder heads 1a. One end of the heat accumulator outlet-side channel E2 is connected to the water coolant outlet of the heat accumulator 101. The other end of the heat accumulator outlet-side channel E2 is connected to a point midway of the radiator inlet-side channel A1. One end of the preheated water coolant inlet-side channel G1 is connected to a point between the reverse flow-preventing valves 39 and the connection described above. The other end of the preheated water coolant inlet-side channel G1 branches fourfold and the branched channels are connected to the water coolant inlets 44 for the corresponding cylinders 2 (#5˜#8) located at the cylinder heads 1a. The reverse flow-preventing valve 40, which circulates water coolant only in the direction shown in FIG. 4, is located midway of the preheated water coolant inlet-side channel G1.

The circulation channel F includes a connecting channel F0, a heat accumulator inlet-side channel F1, a heat accumulator outlet-side channel F2, a heat accumulator 102, a preheated water coolant inlet-side channel H1, a preheated water coolant outlet-side channel H2, and the water jacket 23. The following is how the circulation channel F is connected when the engine 1 is running. One end of the heat accumulator inlet-side channel F1 is connected to the connecting channel E0 through a flow path-switching valve 42. A channel from the cylinder heads 1a to the connecting channel E0 is shared by the circulation channel E. The other end of the heat accumulator inlet-side channel F1 is connected to the water coolant inlet of the heat accumulator 102. One end of the heat accumulator outlet-side channel F2 is connected to the water coolant outlet of the heat accumulator 102. The other end of the heat accumulator outlet-side channel F2 is connected to one end of the connecting channel F0 through a flow path-switching valve 43. The other end of the connecting channel F0 is connected to a point midway of the radiator inlet-side channel A1. The reverse flow-preventing valves 11, which circulate water coolant only in the direction shown in FIG. 4, are located at the water coolant inlet and outlet of the heat accumulator 102.

On the other hand, the following is how the circulation channel F is connected when the engine 1 is turned off. One end of the heat accumulator inlet-side channel F1 is connected to one end of the preheated water coolant outlet-side channel H2 through the flow path-switching valve 42. The other end of the preheated water coolant outlet-side channel H2 branches fourfold and the branched channels are connected to the water coolant outlets 45 for the corresponding cylinders 2 (#1˜#4) located at the cylinder heads 1a. One end of the heat accumulator outlet-side channel F2 is connected to the water coolant outlet of the heat accumulator 102. The other end of the heat accumulator outlet-side channel F2 is connected to one end of the preheated water coolant inlet-side channel H1 through the flow path-switching valve 43. The other end of the preheated water coolant inlet-side channel H1 branches fourfold and the branched channels are connected to the water coolant outlets 44 for the corresponding cylinders 2 (#1˜#4) located at the cylinder heads 1a.

Furthermore, the motor-driven water pump 12 is located between the reverse flow-preventing valve 11 and the flow path-switching valve 41 and midway of the heat accumulator inlet-side channel E1. In the same way, the motor-driven water pump 12 is located between the reverse flow-preventing valve 11 and the flow path-switching valve 42 and midway of the heat accumulator inlet-side channel F1.

A water pump on the circulation channels according to the above description works as follows. Torque from a crankshaft (not shown) is transmitted to the input shaft of the water pump 6 when the engine 1 is running. Then the pump 6 spurts out water coolant driven by pressure according to the torque transmitted to the input shaft of the water pump 6. On the other hand, water coolant does not circulate in the circulation channel A when the engine 1 is turned off since the water pump 6 is turned off.

The water coolant spurted out of the water pump 6 circulates through the water jacket 23. At this time, heat is conducted through the cylinder heads 1a, the interior of the cylinder block, and the water coolant. Some of the heat generated by combustion in the cylinders 2 is conducted to the walls of the cylinders 2. Then the heat is conducted to the cylinder heads 1a and the interior of the cylinder block. As a result, temperatures at the cylinder heads 1a and the entire cylinder block rise. Some of the heat conducted to the cylinder heads 1a and the cylinder block is conducted to the water coolant in the water jacket 23 which leads to raising temperature of the water coolant. As a result, temperatures at the cylinder heads 1a and the cylinder block drop due to heat loss. The water coolant, whose temperature has been raised when engine 1 is running, flows out to the radiator inlet-side channel A1 from the cylinder block. The water coolant does not flow into the reheated water coolant inlet-side channel D1 since the channel includes the reverse flow-preventing valve 40. Water coolant does not circulate in the preheated water coolant inlet-side channel Hi, the preheated water coolant outlet-side channel G2, and the preheated water coolant outlet-side channel H2 since these channels are shut off by the flow path-switching valves 43, 41, and 42 respectively.

The water coolant, which flows out to the radiator inlet-side channel A1, flows into the radiator 9 through the radiator inlet-side channel A1. At this time, heat is conducted to open air from the water coolant. Some of the heat of the high-temperature water coolant is conducted to the walls of the radiator 9. And the heat is conducted to the interior of the radiator 9 which raises the temperature of the entire radiator 9. Then some of the heat, which is conducted to the radiator 9, is conducted to open air. As a result, the temperature of the open air rises. And the temperature of the water coolant drops due to heat loss. Then the lower-temperature water coolant flows out of the radiator 9.

The water coolant, which flows out of the radiator 9, reaches the thermostat 8 through the radiator outlet-side channel A2. When the water coolant, which flows through the heater core outlet-side channel B2, reaches a predetermined temperature, internally stored wax expands to a certain extent. Then the thermostat 8 opens automatically. In other words, the radiator outlet-side channel A2 is shut off when the water coolant, which flows through the heater core outlet-side channel B2, does not reach a predetermined temperature. As a result, the water coolant in the radiator outlet-side channel A2 cannot pass the thermostat 8.

The water coolant, which passes through the thermostat 8, flows into the water pump 6 when the thermostat 8 is open.

As described above, the thermostat 8 opens and water coolant circulates the radiator 9 only when the water coolant reaches a predetermined temperature. The lower-temperature water coolant, which flows through the radiator 9, is spurted out of the water pump 6 to the water jacket 23. Then the temperature of the water coolant rerises.

In the meantime, some of the water coolant, which flows through the radiator inlet-side channel A1, flows into the heater core inlet-side channel B1.

The water coolant, which flows into the heater core inlet-side channel B1, reaches the shut-off valve 31 through the heater core inlet-side channel B1. The shut-off valve 31 is operated by the signals from the ECU 22. The valve is open when the engine 1 is running and the valve is closed when the engine 1 is turned off. The water coolant reaches the heater core 13 after passing the shut-off valve 31 and flowing through the heater core inlet-side channel B1 when the engine 1 is running.

The Heater core 13 exchanges heat with air in a compartment. The warmed air circulates in the compartment by a fan (not shown). As a result, ambient temperature in the compartment rises. Then the water coolant merges into the radiator outlet-side channel A2 after flowing out of the heater core 13 and flowing through the heater core outlet-side channel B2. At this time, the water coolant flows into the water pump 6 after merging with the water coolant in the circulation channel A when the thermostat 8 is open. On the other hand, only the water coolant, which flows through the circulation channel B, flows into the water pump 6 when the thermostat 8 is closed.

As described above, the water coolant, which drops its temperature through the heater core 13, is spurted out of the water pump 6 to the water jacket 23 again.

In this connection, it is necessary that water coolant temperature be raised rapidly when the water coolant temperature is lower than a predetermined temperature. In this case, the water coolant drops its temperature when flowing through radiator. Therefore, it is possible that the water coolant does not reach the predetermined temperature; otherwise it takes a while for the water coolant to reach the predetermined temperature. To prevent the above-mentioned status, the thermostat 8 is provided so that water coolant does not circulate in the radiator 9 and drop its temperature since the thermostat 8 is automatically closed. And low-temperature water coolant does not reversely flow into the heat accumulator 101 and 102 since the heat accumulators are located between the reverse flow-preventing valves 11.

The engine 1 formed according to the above description includes the electronic control unit (ECU hereafter) 22 to control the engine 1. This ECU 22 controls running status of the engine 1 according to running conditions of the engine 1 and requirements from a user. The ECU 22 also has the function of temperature raising control (engine preheat control) when the engine 1 is turned off. The ECU 22 includes various sensors such as a crank position sensor (not shown) and a water coolant temperature sensor (not shown). These sensors are connected each other through electrical wiring so that output signals from the sensors can be inputted to the ECU 22.

Further more, the ECU 22 is connected through electrical wiring with various parts in the engine 1 such as the motor-driven water pump 12, the shut-off valve 31, and the flow path-switching valves (38, 41, 42, and 43) to control these parts.

As shown in FIG. 2, the ECU 22 is equipped with the CPU 351, the ROM 352, the RAM 353, the backup RAM 354, the input port 356, and the output port 357 all of which are connected each other by the bi-directional bus 350. The input port 356 is connected to the A/D converter 355 (A/D 355 hereafter).

The input port 356 inputs output signals from sensors such as a crank position sensor which output digital signals. Then the input port 356 transfers these signals to the CPU 351 and the RAM 353.

The input port 356 inputs output signals through the A/D 355 which outputs analog signals such as a water coolant temperature sensor (not shown). Then the input port 356 transfers these signals to the CPU 351 and the RAM 353.

The output port 357 is connected through electrical wiring with various parts in the engine 1 such as the motor-driven water pump 12, the shut-off valve 31, and the flow path-switching valves (38, 41, 42, and 43). And the output port 357 transfers control signals outputted from the CPU 351 to the above-mentioned parts such as the motor-driven water pump 12, the shut-off valve 31, and the flow path-switching valves (38, 41, 42, and 43).

The ROM 352 stores application programs such as engine preheat-controlling routine to supply heat from the heat accumulator 101 and 102 to the engine 1.

In addition to the above-mentioned application program, the ROM 352 stores various control maps such as fuel injection-controlling map which shows relation between running status of the engine 1 and basic fuel injection amount (basic fuel injection time). Fuel injection timing-controlling map, which shows relation between running status of the engine 1 and basic fuel injection timing, can be presented as another example of a control map.

The RAM 353 stores output signals from each sensor, arithmetic result from the CPU 351 and so on. Engine revolution calculated according to pulse signal intervals from a crank position sensor can be presented as an example of arithmetic result. Data are updated whenever the crank position sensor outputs pulse signals.

The RAM 354 is nonvolatile memory which can store data even if the engine 1 is turned off.

The following explains summary of temperature raising control (engine preheat control hereafter) of the engine 1 according to the present embodiment.

When the engine 1 is running, the ECU 22 transfers signals to the motor-driven water pumps 12 to start the pumps. Then water coolant circulates in the circulation channel E and F. At this time, water coolant can flow into the heat accumulator inlet-side channel E1 from the connecting channel E0 through the flow path-switching valve 41. In the same way, water coolant can flow into the heat accumulator inlet-side channel F1 from the connecting channel E0 through the flow path-switching valve 42 and water coolant can flow into the heat accumulator outlet-side channel F2 from the connecting channel F0 through the flow path-switching valve 43. Therefore, some of the water coolant, which flows through the heater core outlet-side channel B2, can flow into the heat accumulator inlet-side channel E1 and F1. The water coolant, which flows into the heat accumulator inlet-side channel E1, reaches the motor-driven water pump 12 through the heat accumulator inlet-side channel E1. In the same way, the water coolant, which flows into the heat accumulator inlet-side channel F1, reaches the motor-driven water pump 12 through the heat accumulator inlet-side channel F1. The motor-driven water pump 12 is activated by the signals from ECU 22 and spurts out water coolant with a required pressure.

The water coolant, which was spurted out of the motor-driven water pump 12, reaches the heat accumulator 101 through the heat accumulator inlet-side channel E1 and passing the reverse flow-preventing valve 11. In the same way, the water coolant, which was spurted out of the motor-driven water pump 12, reaches the heat accumulator 102 through the heat accumulator inlet-side channel F1 and passing the reverse flow-preventing valve 11. Each heat accumulator has evacuated heat insulation space between the exterior of the container 10a and the interior of the container 10b. The water coolant, which flows into each heat accumulator, is insulated from outside. And the water coolant, which flows in through the water coolant injection tube 10c, flows out of the water coolant extraction tube 10d.

The water coolant, which flows out of the heat accumulator 101, flows into the radiator inlet-side channel A1 after passing the reverse flow-preventing valve 11 and flowing through the heat accumulator outlet-side channel E2. On the other hand, the water coolant, which flows out of the heat accumulator 102, flows into the radiator inlet-side channel A1 after passing the reverse flow-preventing valve 11 and flowing through the heat accumulator outlet-side channel F2 and the connecting channel F0.

The water coolant, which flows out of each heat accumulator and flows into the radiator inlet-side channel A1, flows in different directions depending on whether the engine 1 is running or not. The water coolant flows toward the radiator 9 and the heater core 13 after merging with the water coolant which flows out of the engine 1 when the engine 1 is running.

As described above, the water coolant, whose temperature has been raised by the engine 1, flows through the interior of the heat accumulator 101 and 102. And the interior of each heat accumulator is filled with high-temperature water coolant. Then the high-temperature water coolant can be stored in the heat accumulator 101 and 102 when the ECU 22 stops operating the motor-driven water pump 12 after the engine 1 is turned off. By the insulation effect of the heat accumulator 101 and 102, dropping temperature of the stored water coolant is restrained. The ECU 22 also performs the engine preheat control of the cylinder heads 1a by circulating high-temperature water coolant, which is stored in the heat accumulator 101 and 102, in the circulation channel E and F respectively.

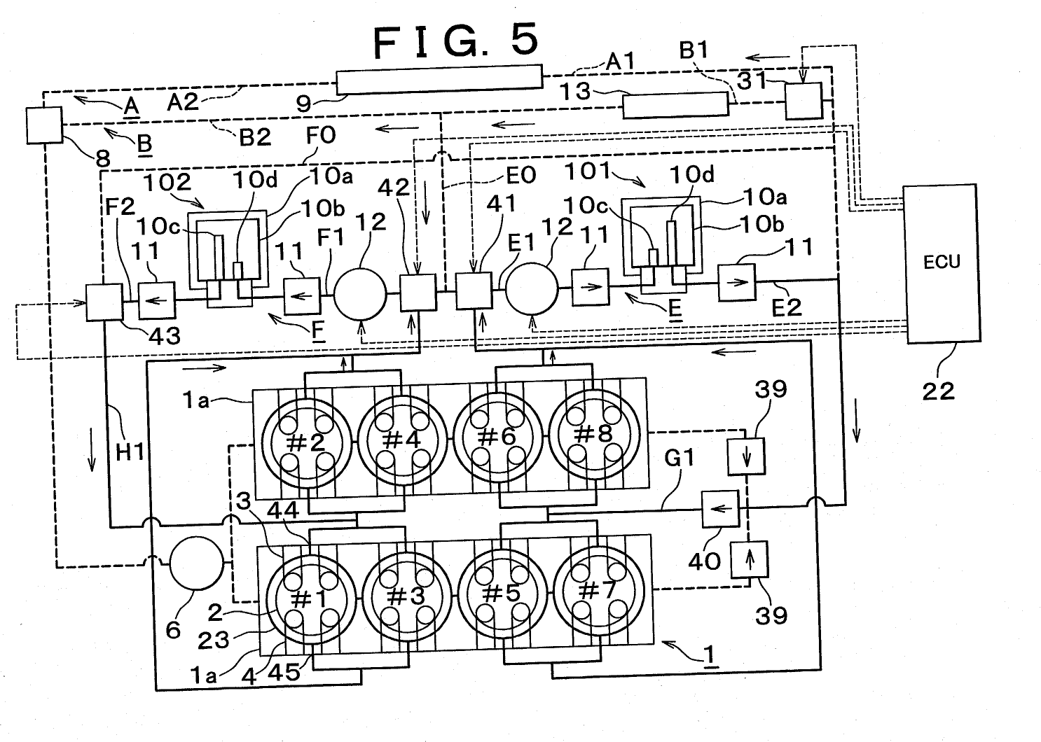

FIG. 5 shows the water coolant circulation channels and the water coolant circulation directions when heat from the heat accumulator 101 and 102 is supplied to the engine 1 and the engine 1 is turned off.

The shut-off valve 31 is closed by the ECU 22 when the engine preheat control is performed. At this time, the section from the preheated water coolant outlet-side channel G2 to the heat accumulator inlet-side channel E1 is open through the flow path-switching valve 41. In the same way, the section from the preheated water coolant outlet-side channel H2 to the heat accumulator inlet-side channel F1 is open through the flow path-switching valve 42 and the section from the preheated water coolant inlet-side channel H1 to the heat accumulator outlet-side channel F2 is open through the flow path-switching valve 43.

The following explains the circulation channel E with the heat accumulator 101. The motor-driven water pump 12, which is located midway of the heat accumulator inlet-side channel E1, is driven according to the signals from the ECU 22 and spurts out water coolant with a required pressure. The spurted out water coolant reaches the heat accumulator 101 through the heat accumulator inlet-side channel E1 and passing the reverse flow-preventing valve 11. At this time, the water coolant, which flows into the heat accumulator 101, is the water coolant whose temperature is lowered when the engine 1 is turned off.

The water coolant, which is stored in the heat accumulator 101, flows out of the heat accumulator 101 through the water coolant extraction tube 10d. At this time, the water coolant, which flows out of the heat accumulator 101, is high-temperature water coolant which is insulated by the heat accumulator 101 after flowing into the heat accumulator 101 when the engine 1 is running. The water coolant, which flows out of the heat accumulator 101, reaches the radiator inlet-side channel A1 after passing the reverse flow-preventing valve 11 and flowing through the heat accumulator outlet-side channel E2. When the engine 1 is turned off, water coolant does not circulate in the heater core 13 since the shut-off valve 31 is closed according to the signal from the ECU 22. And the engine preheat control is not performed when the water coolant temperature is higher than the opening valve temperature of the thermostat 8 since it is not necessary to supply heat from the heat accumulator 101 to the engine 1. In other words, when water coolant circulates and the engine 1 is turned off, the thermostat 8 is always closed. Therefore, the water coolant temperature does not drop due to heat conduction since water coolant does not circulate in the heater core 13 and the radiator 9. As described above, water coolant does not flow in the directions of the radiator 9 and the heater core 13 but flows toward the cylinder heads 1a.

Then the water coolant reaches the reverse flow-preventing valve 39 and the reverse flow-preventing valve 40 through the radiator inlet-side channel A1. At this time, the water coolant cannot pass the reverse flow-preventing valve 39 but the reverse flow-preventing valve 40. The water coolant, which passes the reverse flow-preventing valve 40, flows into the cylinder heads 1a through the water coolant inlets 44 for the corresponding cylinders 2 (#5˜#8) located on the side of intake ports 3 of the cylinder heads 1a through the preheated water coolant inlet-side channel G1 and being branched.

The water coolant, which flows into the cylinder heads 1a, flows through the water jacket 23. The cylinder heads 1a exchange heat with the water coolant in the water jacket 23. Some of the heat from the water coolant is conducted to the interior of the cylinder heads 1a and the temperature of the entire cylinder heads 1a rises. As a result, the water coolant temperature drops due to heat loss. At this time, the water coolant does not flow out to the radiator outlet-side channel A2 through the water pump 6 since the thermostat 8 and the shut-off valve 31 is closed. Therefore, the water coolant, which flows through the water jacket 23, flows into the preheated water coolant outlet-side channel G2 after flowing out of the water coolant outlets 45 for the corresponding cylinders 2 (#5˜#8) located on the side of the intake ports 4 of the cylinder heads 1a. The water coolant, which flows out of the water coolant outlets 45 for the cylinders 2 (#5˜#8), merges into the preheated water coolant outlet-side channel G2 and reaches the motor-driven water pump 12 through the flow path-switching valve 41.

As described above, the ECU 22 raises temperatures of the cylinders 2 (#5˜#8) (engine preheat control) by activating the motor-driven water pump 12 located midway of the heat accumulator inlet-side channel E1 prior to starting the engine 1.

The following explains the circulation channel F with the heat accumulator 102. The motor-driven water pump 12, which is located midway of the heat accumulator inlet-side channel F1, is driven according to the signals from the ECU 22 and spurts out water coolant with a required pressure. The spurted out water coolant reaches the heat accumulator 102 through the heat accumulator inlet-side channel F1 and passing the reverse flow-preventing valve 11. At this time, the water coolant, which flows into the heat accumulator 102, is the water coolant whose temperature is lowered when the engine 1 is turned off.

The water coolant, which is stored in the heat accumulator 102, flows out of the heat accumulator 102 through the water coolant extraction tube 10d. At this time, the water coolant, which flows out of the heat accumulator 102, is high-temperature water coolant which is insulated by the heat accumulator 102 after flowing into the heat accumulator 102 when the engine 1 is running. The water coolant, which flows out of the heat accumulator 102, reaches the preheated water coolant inlet-side channel H1 through the flow path-switching valve 43 after passing the reverse flow-preventing valve 11 and flowing through the heat accumulator outlet-side channel F2.

Then the water coolant flows into the cylinder heads 1a through the water coolant inlets 44 for the corresponding cylinders 2 (#1˜#4) located on the side of the intake ports 3 through the preheated water coolant inlet-side channel Hi and being branched.

The water coolant, which flows into the cylinder heads 1a, flows through the water jacket 23. The cylinder heads 1a exchange heat with the water coolant in the water jacket 23. Some of the heat from the water coolant is conducted to the interior of the cylinder heads 1a and the temperature of the entire cylinder heads 1a rises. As a result, the water coolant temperature drops due to heat loss. At this time, the water coolant does not flow out to the radiator outlet-side channel A2 through the water pump 6 since the thermostat 8 and the shut-off valve 31 is closed. Therefore, the water coolant, which flows through the water jacket 23, flows out of the water coolant outlets 45 of for the corresponding cylinders 2 (#1˜#4) located on the side of the intake ports 4 of the cylinder heads 1a. The water coolant, which flows out of the water coolant outlets 45 of for cylinders 2, merges into the preheated water coolant outlet-side channel H2 and reaches the motor-driven water pump 12 through the flow path-switching valve 42.

As described above, the ECU 22 raises temperatures of the cylinders 2 (#1˜#4) (engine preheat control) by activating the motor-driven water pump 12 located midway of the heat accumulator inlet-side channel F1 prior to starting the engine 1.

According to the present preferred embodiment described above, the engine includes the two heat accumulators. Furthermore, the engine includes the four circulation channels so that one heat accumulator can raise temperatures of half of the cylinders and the other heat accumulator can raises temperatures of the rest of the cylinders. Therefore, differences in temperature among the cylinders 2 can be decreased since water coolant can flow through each cylinder 2 by utilizing a heat accumulator connected to low-temperature cylinders 2. And the water coolant, which flows into one of the cylinder heads 1a from one of the water coolant inlets 44, only raises a temperature of one of cylinders 2 so that a period of finishing the engine preheat control can be shortened.

Although water coolant flows through the two groups of cylinders (#1˜#4 and #5˜#8) according to the present preferred embodiment, grouping of the cylinders may be altered at will. And more than one heat accumulator may be provided. For example, the cylinders may be grouped according to temperature characteristics. In this case, one heat accumulator supplies water coolant to a group of cylinders with similar temperature characteristics. As another example, temperature-raising control may be performed according to the measured temperatures after measuring temperatures of water coolant in each independent circulation channel.

Water coolant may be heated by a device such as a heater according to the present preferred embodiment so that the lower-temperature water coolant after supplying heat to the engine 1 can be heated. Therefore, the engine 1 can be heated for a long period.

Different operation control may be performed for each cylinder according to the present preferred embodiment.

As explained above, rapid raising temperatures of the cylinders 2 is possible when the engine 1 is turned off according to the present preferred embodiment. As a result, warm-up period can be shortened dramatically. And differences in temperature among the cylinders 2 can be decreased. Therefore, stating the engine 1 without raising temperatures of the cylinders 2 sufficiently can be prevented.

As a result of providing plural heat accumulators, water coolant store volume for one heat accumulator can be decreased. Therefore, downsizing containers is possible which improves capacities of a vehicle.

The Third Embodiment

The following explains the differences between the engine 1 according to the first embodiment and an engine equipped with a heat accumulator according to the present preferred embodiment.

According to the first embodiment, physical relations between the each water coolant inlet 44 and the water jacket 23 are not specified. However, water coolant inlets 44 are provided at positions to generate swirling flow in the water jacket 23.

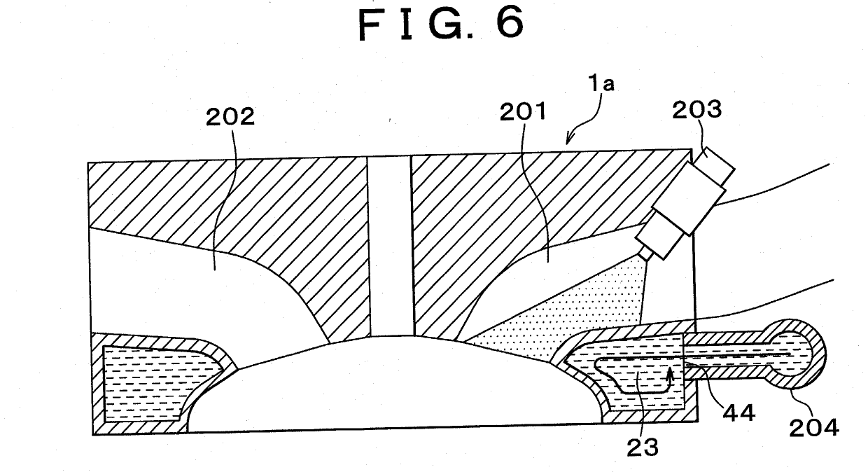

FIG. 6 is a schematic view of an engine 1 applying a heat accumulator for an internal combustion engine and water coolant channels (circulation channels) in which water coolant circulates according to the present preferred embodiment.

An intake port 201, an exhaust port 202, and the water jacket 23, through which water coolant flows, are provided at the cylinder head 1a. A discharge hole of the water jacket 23 is provided at the cylinder head 1a in a way that the discharge hole faces the interior of the intake port 201. A fuel infection valve 203, which is opened by the signals from the ECU 22 to inject fuel, is provided at the cylinder head 1a. Furthermore, a delivery pipe 204, which connects a heat accumulator and the water jacket 23, is connected to the cylinder head 1a. The delivery pipe 204 is connected at the water coolant inlet 44 provided close to an upper middle part of the water jacket 23 in FIG. 6. Furthermore, the water coolant inlet 44 is provided at each cylinder.

With the heat accumulator for an internal combustion engine, which comprises as described above, high-temperature water coolant supplied from the heat accumulator (not shown) flows into the water jacket 23 through the delivery pipe 204 before or immediately after starting the engine. Water coolant, which flows into the water jacket 23, hits a wall of the water jacket 23 and flows along the wall toward a lower middle part of the water jacket 23 in FIG. 6. Then the water coolant generates swirling flow in the water jacket 23.

When water coolant flows along the wall of the water jacket 23, the water coolant exchanges heat with the wall so that a temperature at the wall of the water jacket 23 rises. Then a temperature at the intake port 201 rises through heat conduction since the wall of the water jacket 23 and the intake port 201 are adjacent. Though a portion of fuel injected from the fuel injection valve 203 adheres to a wall of the intake port 201, evaporation of the adhered fuel is accelerated by heat conducted from the water jacket 23.

At this time, flow velocity of the water coolant increases due to the generation of swirling flow in the water jacket 23. By the generation of the swirling flow, heat conductivity increases so that the amount of heat conducted to the wall of the water jacket 23 increases. Therefore, a temperature at the wall of the intake port can be raised rapidly. Furthermore, a temperature at a portion of the intake port 201 with adhered fuel from the fuel injection valve 203 can be raised in preference to the other portions of the intake port 201. Therefore, evaporation of fuel is accelerated even immediately after starting the engine.

An opening location of the water coolant inlet 44 is not limited to an upper part of the water jacket 23. It may be a lower part or a center part of the water jacket 23. In these cases, an inflow angle of water coolant, which flows into the water jacket 23 from the water coolant inlet 44, is adjusted to generate swirling flow.

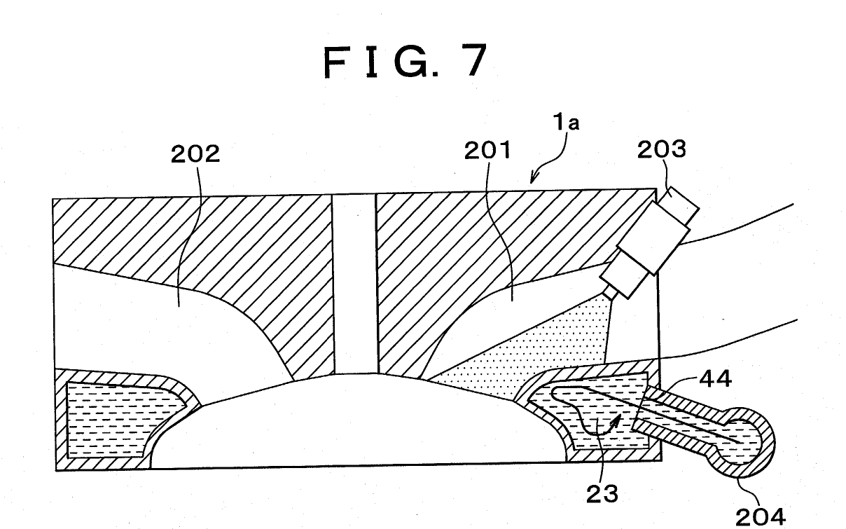

FIG. 7 is a schematic view showing the cylinder head 1a including the water coolant inlet 44 at a central part of the water jacket 23. The delivery pipe 204 is angled when it is provided to introduce water coolant toward an upper middle part of the water jacket 23 in FIG. 7. By angling the delivery pipe 204 when it is provided, water coolant can flow along the wall of the water jacket 23 and generate swirling flow. An opening location of the water coolant inlet 44 and an inflow angle of water coolant from the water coolant inlet 44 to the water jacket 23 can be determined through an experiment. In this case, the inflow angle may be set in a way that a temperature at a portion with the necessity of raising temperature such as a portion in the intake port 201 where fuel adheres can be raised the most.

As described above, swirling flow is generated in the water jacket 23 and heat conductivity increases according to the present preferred embodiment so that the wall of the intake port 201 can be heated rapidly. Therefore, effects of decreasing the amount of fuel adhering to the wall of the intake port 201, improving starting characteristics, restraining deterioration of emission, and improving mileage can be obtained. Furthermore, the amount of increase in fuel for starting the engine, which is generally needed, can be decreased.

Though the structure, in which the delivery pipe 204 is connected to the cylinder head 1a, is adopted according to the present preferred embodiment, the delivery pipe 204 may be formed integrally with the cylinder head 1a to decrease the number of parts.

The Fourth Embodiment

The following explains the differences between the engine 1 according to the first embodiment and an engine equipped with a heat accumulator according to the present preferred embodiment.

According to the first embodiment, physical relations between each water coolant inlet 44 and the water jacket 23 are not particularly considered. However, the water coolant inlets 44 are provided in consideration of flow of water coolant in the water jacket 23 according to the present preferred embodiment.

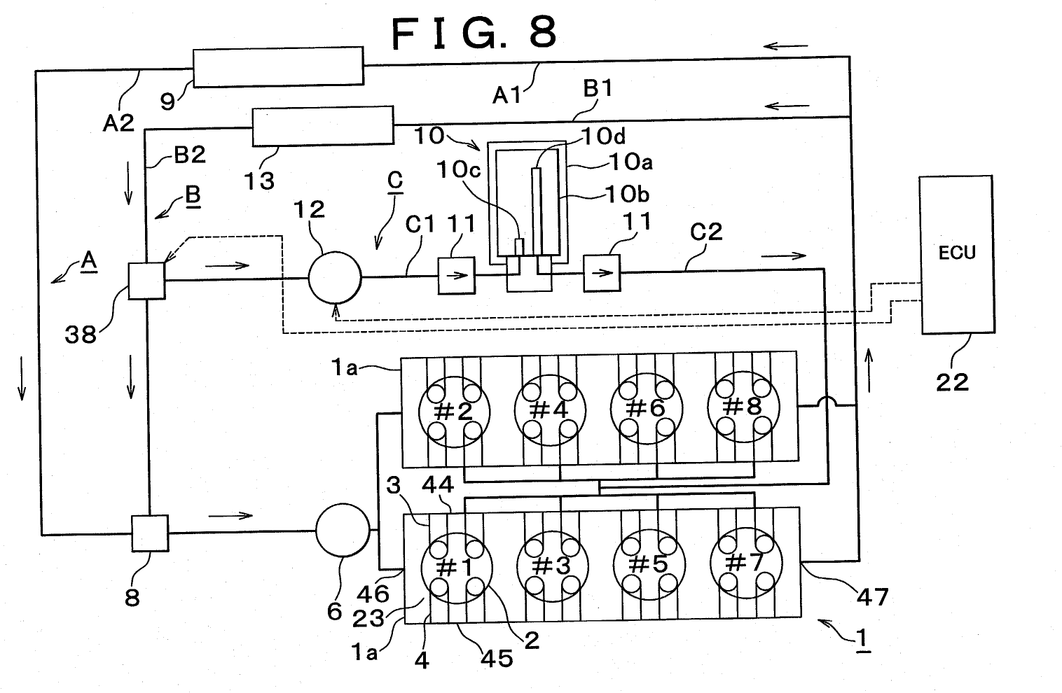

FIG. 8 is a schematic view of an engine 1 applying a heat accumulator for an internal combustion engine relating to the present invention and water coolant channels (circulation channels) A, B, and C in which water coolant in the engine 1 circulates according to the fourth embodiment. The arrows along the circulation channels show the flow directions of water coolant when the engine 1 is running.

The engine 1 shown in FIG. 8 is a water-cooled 4-cycle V-type engine with 8 cylinders, which is run by gasoline and equipped with two cylinder heads 1a.

The cylinder heads 1a are equipped with the water jacket 23 through which water coolant circulates. A water pump 6, which sucks in water coolant outside the engine 1 and spurts out the water coolant inside the engine 1, is provided at the water coolant inlet of the water jacket 23. The water pump 6 is driven by torque of the output shaft of the engine 1. In other words, the water pump 6 can only be driven when the engine 1 is running.

There are three circulation channels as channels to circulate water coolant through the engine 1: the circulation channel A which circulates through a radiator 9, the circulation channel B which circulates through a heater core 13, and the circulation channel C which circulates through the heat accumulator 10. Each circulation channel shares a section with another circulation channel.

The circulation channel A has the main function of lowering water coolant temperature by emitting heat of the water coolant from the radiator 9.

The circulation channel A includes the radiator inlet-side channels A1, the radiator outlet-side channel A2, the radiator 9, and the water jacket 23. One end of the radiator inlet-side channel A1 is branched and connected to water coolant outlets 47 provided at the two cylinder heads 1a. The other end of radiator inlet-side channel A1 is connected to the water coolant inlet of the radiator 9.

One end of the radiator outlet-side channel A2 is connected to the water coolant outlet of the radiator 9. The other end of the radiator outlet-side channel A2 is connected to a water coolant inlet 46 provided at a cylinder block (not shown). The radiator outlet-side channel A2 from the water coolant outlet of the radiator 9 to the cylinder block has the thermostat 8. The thermostat 8 has the function of opening its valve when water coolant reaches a predetermined temperature. The water pump 6 is located between the radiator outlet-side channel A2 and the cylinder block.

The circulation channel B has the main function of raising ambient temperature in a compartment by emitting heat of water coolant from the heater core 13.

The circulation channel B includes the heater core inlet-side channel B1, the heater core outlet-side channel B2, the heater core 13, and the water jacket 23. One end of the heater core inlet-side channel B1 is connected to a point midway of the radiator inlet-side channel A1. A channel from the cylinder heads 1a to the connection described above, which is a part of the heater core inlet-side channel B1, is shared by the radiator inlet-side channel A1. The other end of the heater core inlet-side channel B1 is connected to the water coolant inlet of the heater core 13. One end of the heater core outlet-side channel B2 is connected to the water coolant outlet of the heater 13. The other end of the heart core outlet-side channel B2 is connected to the thermostat 8, which is located midway of the radiator outlet-side channel A2. The water jacket 23 and a channel from the thermostat 8 to the cylinder block are shared by the radiator outlet-side channel A2.

The circulation channel C has the main function of warming the engine 1 by accumulating heat of water coolant and emitting the accumulated heat.

The circulation channel C includes the heat accumulator inlet-side channel C1, the heat accumulator outlet-side channel C2, the heat accumulator 10, and the water jacket 23. One end of the heat accumulator inlet-side channel C1 is connected to one end of the heater core outlet-side channel B2 thorough the flow path-switching valve 38 which is controlled by the signals from the ECU 22. A channel from the cylinder heads 1a to the connection described above is shared by the circulation channel B. The other end of the heat accumulator inlet-side channel C1 is connected to the water coolant inlet of the heat accumulator 10. One end of the heat accumulator outlet-side channel C2 is connected to the water coolant outlet of the heat accumulator 10. The other end of the heat accumulator outlet-side channel C2 branches fourfold to correspond to the three cylinders 2 and the branched channels are connected to the cylinder head 1a. The reverse flow-preventing valves 11, which circulate water coolant only in the direction shown in FIG. 8, are located at the water coolant inlet and outlet of the heat accumulator 10. Furthermore, the motor-driven water pump 12 is located midway of the heat accumulator inlet-side channel C1 and upstream the reverse flow-preventing valve 11.

In the circulation channels comprising as described above, water coolant circulates in the directions of the arrows in FIG. 8 when the engine 1 is running and water coolant, whose temperature has been raised, is stored in the heat accumulator 10. At this time, the flow path-switching valve 38 connects the upstream and the downstream of the heater core outlet-side channel B2 and the heat accumulator inlet-side channel C1.

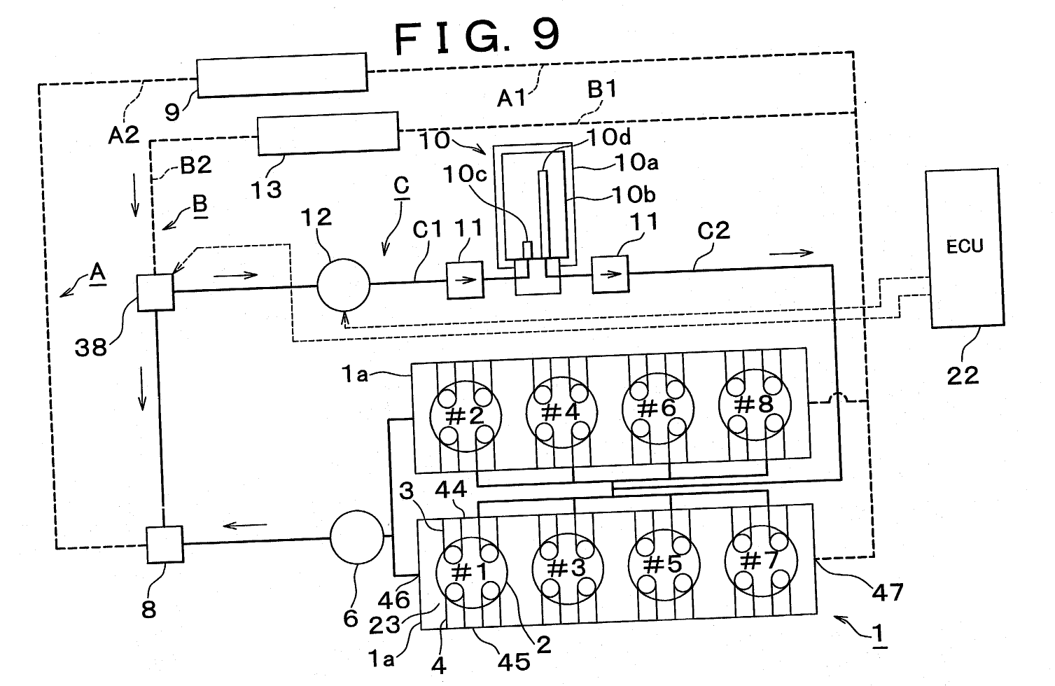

FIG. 9 is a view of the circulation channels and circulation directions of water coolant when the engine preheat control is carried out. At this time, the flow path-switching valve 38 connects only the heat accumulator inlet-side channel C1 and the heater core outlet-side channel B2 on the side of the thermostat 8. In other words, the heater core outlet-side channel B2 on the side of the heater core 13 is shut off so that water coolant does not flow through the heater core 13 at this time.

When the engine preheat control is carried out, the motor-driven water pump 12 is driven according to the signals from the ECU 22 to introduce water coolant in the directions of the arrows shown in FIG. 9.

In other words, water coolant, which has flowed out of the heat accumulator 10, flows into the cylinder heads 1a from the eight inlets 44 provided on the side of the intake ports 3 after passing the reverse flow-preventing valve 11, flowing through the heat accumulator outlet-side channel C2, and being branched. The water coolant, which flowed out of the heat accumulator 10 at this time, is high-temperature water coolant insulated by the heat accumulator 10 after flowing into the heat accumulator 10 when the engine is running.

The water coolant, which has flowed into the cylinder heads 1a, reaches the water coolant inlet 46 after flowing the water jacket 23. Then the water coolant flows back to the motor-driven water pump 12 through the flow path-switching valve 38 after reversely flowing at the water coolant inlet 46 and flowing out to the heater core outlet-side channel B2.

As described above, the ECU 22 drives the motor-driven water pump 12 to raise temperatures at the cylinder heads 1a (the engine preheat control) prior to starting the engine 1.

If the water coolant inlet 44 of water coolant is provided at each cylinder 2 as described above, differences in temperature among the cylinders 2 can be decreased since water coolant can be supplied to each cylinder 2. Furthermore, water coolant, which flows into one of the cylinder heads 1a from one of the water coolant inlets 44, may only raises a temperature of one of cylinders 2 so that a period of finishing the engine preheat control can be shortened.

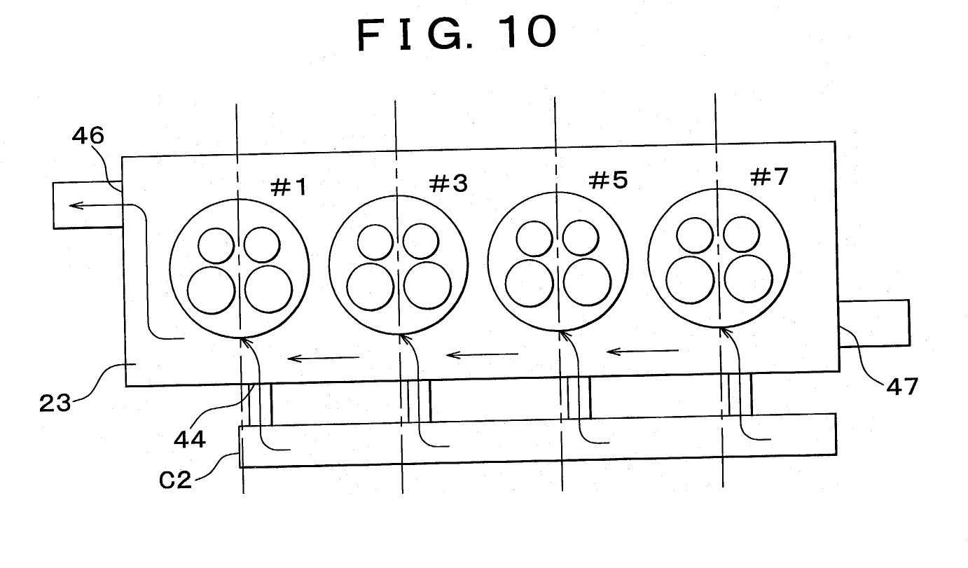

Each water coolant inlet 44 is eccentrically provided to the side of the water coolant outlet 47 from the center of each cylinder 2 according to the present preferred embodiment. FIG. 10 is a schematic view of the cylinder head 1a including the water coolant inlets 44 eccentrically provided to the side of the water coolant outlet 47 from the center of each cylinder 2. In the internal combustion engine equipped with the heat accumulator comprising as described above, water coolant flows into the water jacket 23 from the water coolant inlets 44 when the engine preheat control is carried out.

In the water jacket 23, water coolant flows toward the water coolant inlet 46 and flows out to the outside of the engine 1 from the water coolant inlet 46. Therefore, water coolant flow toward the water coolant inlet 46 exists in the water jacket 23. The water coolant, which has flowed into the water jacket 23 from the water coolant inlets 44, is introduced toward the water coolant inlet 46 according to the water coolant flow in the water jacket 23. Therefore, raising temperature at a desired portion becomes difficult since water coolant supplied from the water coolant inlets 44 is introduced toward the downstream even if the water coolant inlets 44 are provided in a way that they face the desired portion. Therefore, in the case of the intake port 3, for example, as a desired portion where its temperature needs to be raised, a temperature of the intake port 3 on the side of the water coolant inlet 46 become higher than a temperature of the intake port 3 on the side of the water coolant outlet 47.

To obviate the above-mentioned problem, the water coolant inlets 44 are eccentrically provided to the side of the water coolant outlet 47 in consideration of the water coolant flow in the water jacket 23. Therefore, water coolant can reach a desired portion even if the water coolant, which has flowed into the water jacket 23 from the water coolant inlets 44, is introduced to the side of the water coolant inlet 46. Locations for providing the water coolant inlets can be determined by an experiment.

According to the present preferred embodiment, the water coolant inlets 4 may be provided not only upstream the water coolant flow in the water jacket 23 but also downstream or on the center axes of the cylinders 2. In this case, water coolant, which flows into the water jacket 23 from the water coolant inlets 44, should be introduced to the side of the water coolant outlet 47.

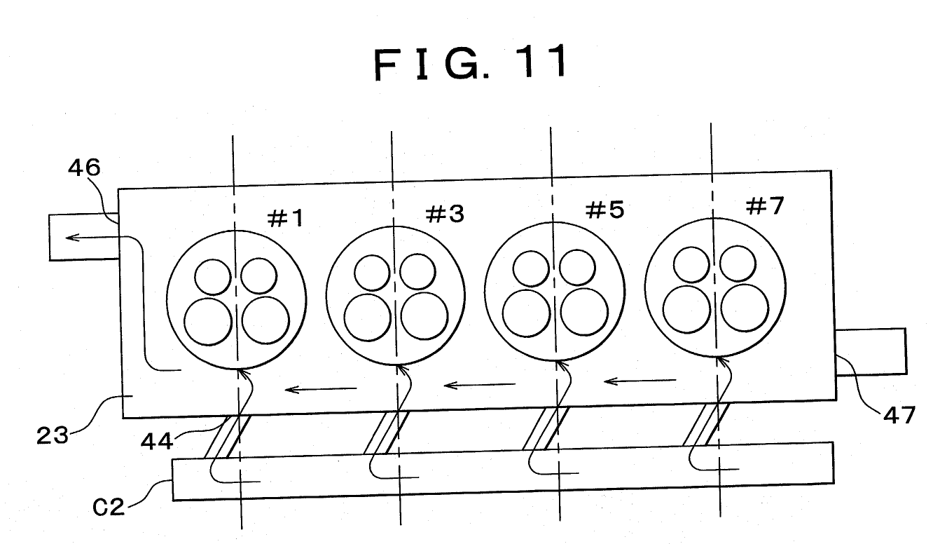

FIG. 11 is a schematic view showing a cylinder head including water coolant inlets 44 provided on the center axis of each cylinder 2. In the schematic view, water coolant channels from the heat accumulator outlet-side channel C2 to the water jacket 23 are angled to the upstream direction of the water coolant flow, in other words, to the water coolant outlet 47. By angling as described above, water coolant, which has flowed into the water jacket 23, is introduced to the side of the water coolant inlet 46 according to the water coolant flow after temporarily flowing out to the side of the water coolant outlet 47. Therefore, high-temperature water coolant can be introduced to a desired portion where its temperature needs to be raised.

According to the present invention, plural water coolant inlets may be provided at each cylinder. In this case, simultaneously raising temperatures at plural desired portions where their temperatures need to be raised is possible. As explained above, high-temperature water coolant can be introduced to a desired portion where its temperature needs to be raised and rapidly raising temperature at a wall of the intake port 3 is possible by providing the water coolant inlets 44 in consideration of water coolant flow in the water jacket 23. Therefore, the amount of fuel adhering to the wall of the intake port 3 can be decreased and starting characteristics of the engine can be improved. Furthermore, the amount of increased fuel for starting the engine, which is generally needed, can be decreased and mileage can be improved. Furthermore, differences in temperature among the ports can be decreased if each cylinder includes plural ports.

Though the structure, in which the heat accumulator outlet-side channel C2 is branched outside the cylinder heads 1a and connected to the cylinder heads 1a, is adopted according to the present preferred embodiment, the heat accumulator outlet-side channel C2 may be branched in the cylinder heads 1a to decrease the number of parts.

The Fifth Embodiment

The following explains the differences between the engine 1 according to the first embodiment and an engine equipped with a heat accumulator according to the present preferred embodiment. According to the present preferred embodiment, the water coolant inlets 44, which are for supplying high-temperature water coolant from a heat accumulator, are provided at the cylinder block 1b.

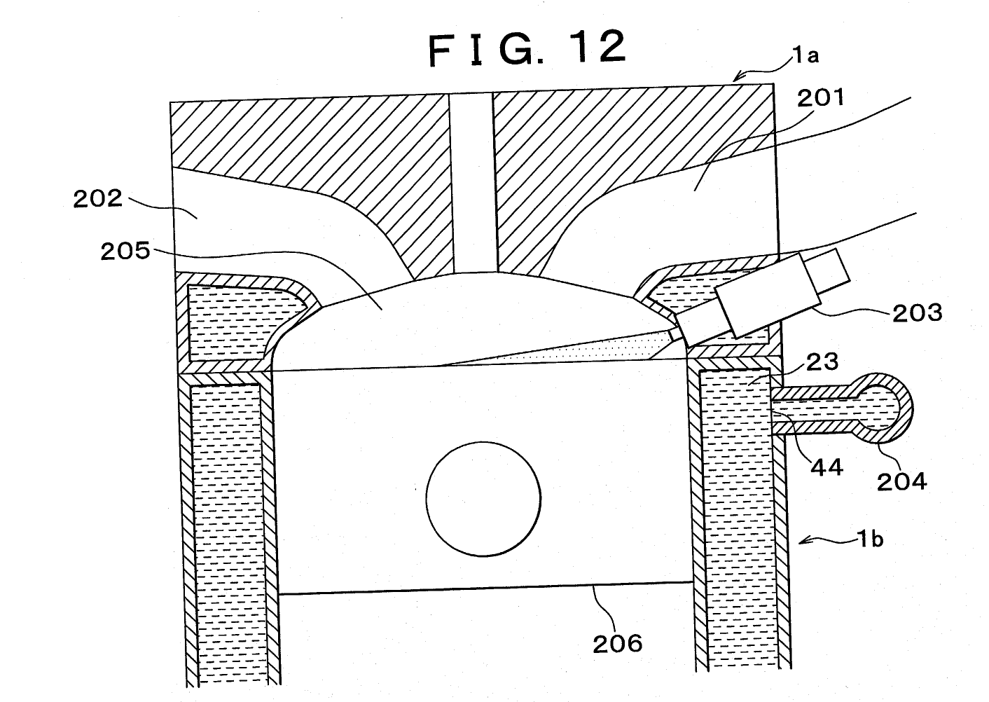

FIG. 12 is a schematic view showing an in-pipe fuel-injected internal combustion engine including the water coolant inlets 44 located at a cylinder block.

Engine 1 includes the cylinder head 1a and the cylinder block 1b.

The intake port 201 which is a circulation channel for intake gas, the exhaust port 202 which is a circulation channel for exhaust gas, and the water jacket 23 which is a circulation channel for water coolant are formed at the cylinder head 1a. A discharge hole is provided at the cylinder head 1a in a way that the discharge hole faces the interior of a combustion chamber 205. The fuel infection valve 203, which is opened by the signals from the ECU 22 to inject fuel, is also provided at the cylinder head 1a.

A piston 206 is provided at the cylinder block 1b. Furthermore, the water jacket 23 is formed at the cylinder block 1b. The delivery pipe 204, which is connected to the water jacket 23, is provided on the side of the intake port 201 of the cylinder block 1b. The delivery pipe 204 is connected through the water coolant inlets 44 provided at the cylinder block 1b. The water coolant inlets 44 are provided at each cylinder.

With the heat accumulator for an internal combustion engine, which comprises as described above, high-temperature water coolant supplied from the heat accumulator (not shown) flows into the water jacket 23 through the delivery pipe 204 before or immediately after starting the engine. Water coolant, which has flowed into the water jacket 23, exchanges heat with a portion of the cylinder block 1b on the side of the intake port 201 and the heat is conducted to the cylinder block 1b. Furthermore, the cylinder block 1b exchanges heat with the piston 206 and the heat is conducted to the piston 206. Therefore, a temperature of a wall of the cylinder and the piston 206 can be raised.

When the engine is running, a portion of fuel injected from the fuel injection valve 203 adheres to an upper part of the piston 206. If a temperature of the piston 206 is low when the engine is stating, evaporation of the adhered fuel on the upper part of the piston 206 slows down and smoke may be generated.

However, a temperature of the piston can be raised even before or immediately after stating the engine and smoke can be decreased according to the present preferred embodiment. In addition, the amount of increase in fuel can be decreased and mileage can be improved. Furthermore, lubricant, which adheres to the cylinder block 1b, is heated immediately after starting the engine by heating the cylinder block 1b so that friction loss can be decreased and mileage can be improved.

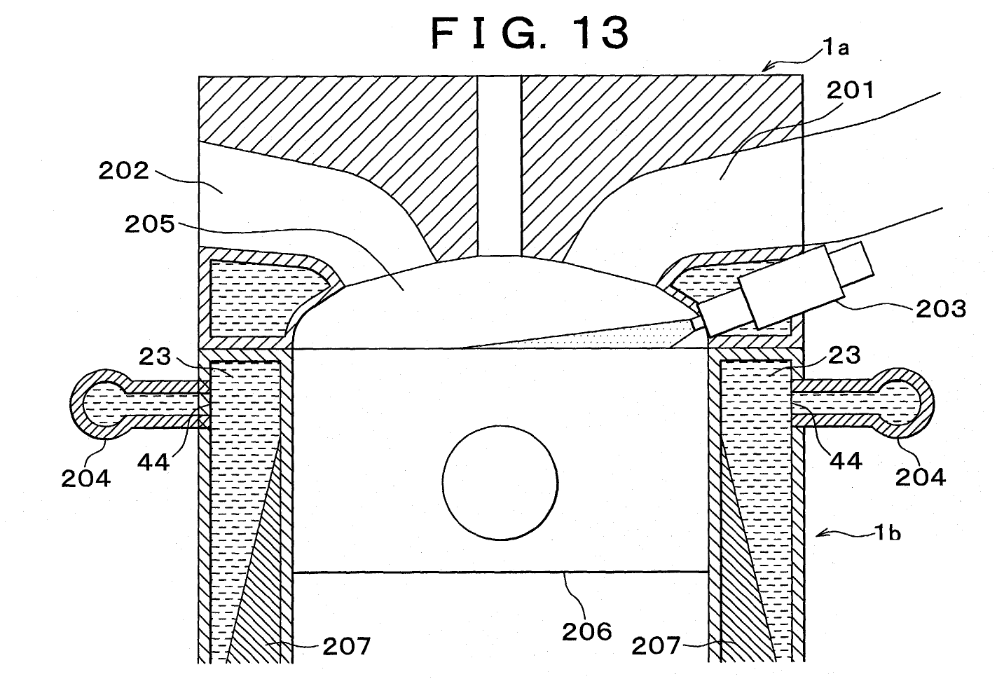

FIG. 13 is a schematic view of an in-pipe fuel-injected internal combustion engine including two water coolant inlets located at a cylinder block. Compared with the in-pipe fuel-injected internal combustion engine shown in FIG. 12, the differences are: a water coolant inlet is provided on the side of the exhaust port 202 and a spacer 207 is provided in the water jacket 23 in the cylinder block 1b to reduce flow area of the water jacket 23.

With the heat accumulator for an internal combustion engine, which comprises as described above, the amount of water coolant in the cylinder block 1b is reduced by a spacer 207 and high-temperature water coolant can be supplied to a portion where its temperature needs to be raised. In addition, the piston 206 and a wall of the cylinder can be heated from both sides of the intake port 201 and the exhaust port 202. Therefore, compared with a cylinder block with one water coolant inlet, a period of finishing the engine preheat control can further be shortened and friction loss can further be decreased.

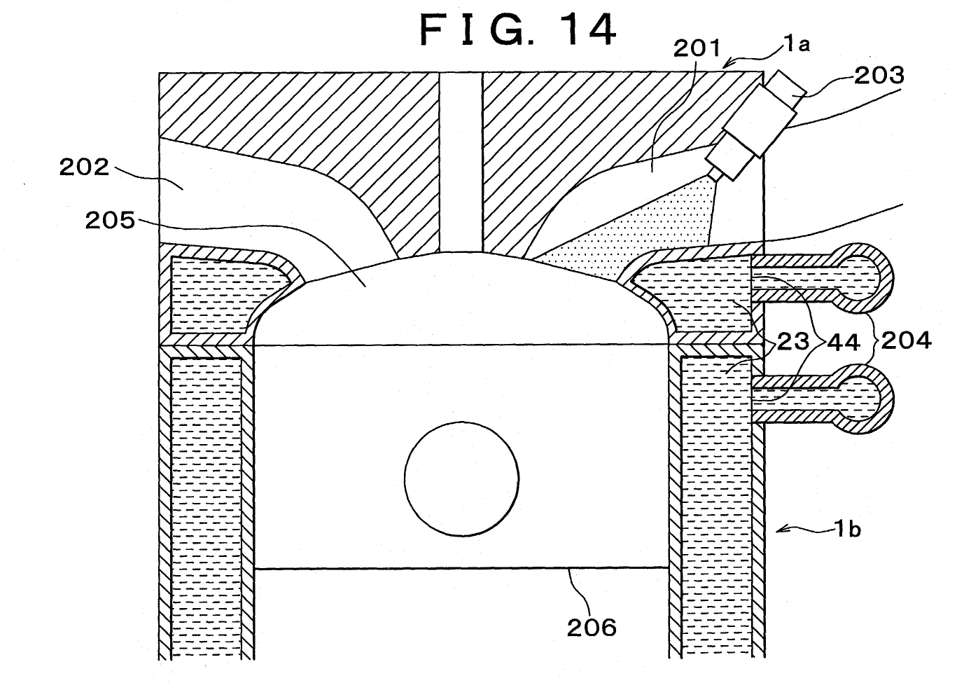

FIG. 14 is a schematic view showing an in-port fuel-injected internal combustion engine with water coolant inlets provided at a cylinder head and a cylinder block.

The engine 1 includes the cylinder head 1a and the cylinder block 1b.

The intake port 201 which is a circulation channel for intake gas, the exhaust port 202 which is a circulation channel for exhaust gas, and the water jacket 23 which is a circulation channel for water coolant are formed at the cylinder head 1a. A discharge hole is provided at the cylinder head 1a in a way that the discharge hole faces the interior of the intake port 201. The fuel infection valve 200, which is opened by the signals from the ECU 22 to inject fuel, is also provided at the cylinder head 1a. The delivery pipe 204, which is connected to the water jacket 23, is connected to the cylinder head 1a. The delivery pipe 204 is connected at the water coolant inlets 44, which are provided at each cylinder.

The piston 206 is provided at the cylinder block 1b. Furthermore, the water jacket 23 is formed at the cylinder block 1b. The delivery pipe 204, which is connected to the water jacket 23, is provided on the side of the intake port 201 of the cylinder block 1b. The delivery pipe 204 is connected through the water coolant inlets 44 provided at the cylinder block 1b. The water coolant inlets 44 are provided at each cylinder.

With the heat accumulator for an internal combustion engine, which comprises as described above, high-temperature water coolant supplied from the heat accumulator (not shown) flows into the water jacket 23 through the delivery pipe 204 before or immediately after starting the engine. Water coolant, which has flowed into the water jacket 23, exchanges heat with a wall of the water jacket 23 and a temperature of the wall of the water jacket 23 rises. The wall of the water jacket 23 and the intake port 201 are adjacent so that a temperature of the intake port 201 rises through heat conduction. On the other hand, the water coolant, which has flowed into the water jacket 23, exchanges heat with a portion of the cylinder block 1b on the side of the intake port 201 and the heat is conducted to the cylinder block 1b. Furthermore, the cylinder block 1b exchanges heat with the piston 206 and the heat is conducted to the piston 206. Therefore, a temperature of a wall of the cylinder and the piston 206 can be raised.

As described above, temperatures of the intake port 201, the piston 206, and the wall of the cylinder can be raised even before starting the engine and smoke can be decreased. In addition, the amount of increase in fuel can be decreased and mileage can be improved. Furthermore, lubricant, which adheres to the cylinder block 1b, is heated immediately after starting the engine by heating the cylinder block 1b so that friction loss can be decreased and mileage can be improved.

Though the structure, in which the delivery pipe 204 is connected to the cylinder head 1a and the cylinder block 1b, is adopted according to the present preferred embodiment, the delivery pipe 204, the cylinder head 1a, and the cylinder block 1b may be integrally formed to reduce the number of parts.

According to an internal combustion engine equipped with a heat accumulator relating to the present invention, a heat medium with approximately the same amount of heat for each inlet flows in simultaneously since the internal combustion engine is equipped with plural inlets to introduce a heat medium into the internal combustion engine.

As a result, every portion around each inlet in the internal combustion engine can be warmed rapidly and equally. Therefore, rapid completion of warming up the internal combustion engine is possible and a temperature does not differ at each portion around the water coolant inlets.

Also, a water coolant inlet can be made at each combustion chamber of a cylinder and each intake port as a warm-up effective portion. If a water coolant inlet is provided at each cylinder as mentioned above, differences in temperature among the cylinders can be decreased since a heat medium with the same temperature flows into each cylinder simultaneously and the heat medium can circulate only through a portion where temperature-raising is needed. Furthermore, a period of finishing circulating the heat medium can be shortened since the heat medium circulates through each cylinder simultaneously.

Furthermore, with an internal combustion engine including a heat accumulator relating to the present invention, warming up the internal combustion engine can be finished rapidly by generating swirling flow of water coolant and increasing heat conductivity.

Furthermore, with an internal combustion engine including a heat accumulator relating to the present invention, heat from a heat medium can be supplied to a portion where its temperature needs to be raised in consideration of flow of water coolant so that rapid warming up can be performed.

Relating to the above description, characteristics among the cylinders may be measured and heat medium-supplying control may be performed according to a predetermined characteristic of each cylinder. Furthermore, plural temperature measurer may be provided to measure each warm-up effective portion. And the heat medium-supplying control may be performed according to the measured temperatures by the plural temperature measurer.

What is claimed is:

1. An internal combustion engine equipped with a heat accumulator, comprising:
a heat accumulator that accumulates a heat medium heated during an operation of the engine while inhibiting a decrease in temperature of the heat medium;
a heat supplier that supplies the heat medium accumulated in the heat accumulator to the internal combustion engine; and
plural inlets that introduce the heat medium supplied by the heat supplier to the internal combustion engine.

2. The internal combustion engine according to claim 1, wherein
the internal combustion engine is equipped with multiple cylinders and the plural inlets are provided at each cylinder.

3. The internal combustion engine according to claim 1, wherein
more than one of the heat accumulator is provided;
the heat supplier is provided at each heat accumulator; and
each heat accumulator supplies with the heat medium to at least one of the plural inlets and the one inlet is supplied with the heat medium by only one of the heat accumulators.

4. The internal combustion engine according to claim 3, wherein
each heat supplier controls the supply of the heat medium independently of another heat supplier.

5. The internal combustion engine according to claim 3, wherein
each heat supplier controls the supply of the heat medium according to a difference between characteristics of the cylinders.

6. The internal combustion engine according to claim 3, further comprising:
plural temperature measurers that measure a temperature at each cylinder, wherein
the heat supplier controls the supply of the heat medium based on temperatures measured by the temperature measurers.

7. The internal combustion engine according to claim 3, wherein
the heat supplier groups the cylinders and controls the supply of the heat medium per each group.

8. The internal combustion engine according to claim 7, wherein
the grouping is carried out based on a temperature characteristic at each cylinder.

9. The internal combustion engine according to claim 3, wherein
the heat supplier controls the supply of the heat medium according to a different control method at each cylinder.

10. The internal combustion engine according to claim 1, wherein
the inlets are where the heat medium in the internal combustion engine flows into a warm-up effective portion which is an effective portion to warm up the internal combustion engine.

11. The internal combustion engine according to claim 10, wherein
the warm-up effective portion at least includes a combustion chamber and an intake port which compose each cylinder.

12. The internal combustion engine according to claim 10, wherein
the inlets are provided on the internal combustion engine with angles to send the heat medium through the inlets to the warm-up effective portion after merging into the flow of heat medium flowing in the internal combustion engine.

13. The internal combustion engine according to claim 10, wherein
the inlets are provided upstream side of the warm-up effective portion with respect to the heat medium flowing direction in the internal combustion engine.

14. The internal combustion engine according to claim 1, wherein
the inlets are provided on the internal combustion engine with angles to generate swirling flow for the heat medium in the internal combustion engine.

15. The internal combustion engine according to claim 1, wherein
the inlets are connected to a water jacket in the internal combustion engine.

16. The internal combustion engine according to claim 1, further comprising:
a water jacket where the heat medium flowing into the internal combustion engine circulates, wherein
locations of the inlets and inflow angles of the heat medium are set so that the heat medium flowing into the water jacket from the inlets swirls in the water jacket.

17. The internal combustion engine according to claim 1, further comprising:
a water jacket where the heat medium flowing into the internal combustion engine circulates, wherein
locations of the inlets and inflow angles of the heat medium are set so that the heat medium, which has flowed into the water jacket from the inlets, reaches a portion where the heat medium needs to be supplied after being introduced by flow of the heat medium in the water jacket.

18. The internal combustion engine according to claim 1, wherein
the heat medium is water coolant.

19. The internal combustion engine according to claim 1, further comprising:
a heating device that heats the heat medium.

20. The internal combustion engine according to claim 19, wherein
the heating device is a heater.

21. The internal combustion engine according to claim 1, wherein
the heat supplier includes plural circulation channels that circulate the heat medium in the internal combustion engine.

22. The internal combustion engine according to claim 21, wherein
the heat supplier detects a temperature at each circulation channel and controls the supply of the heat medium based on the detected temperature.
